(19) United States
(12) Patent Application Publication
(10) Pub. No.: US 2024/0224243 A1
(43) Pub. Date: Jul. 4, 2024

(54) REPEATER, NETWORK NODE AND METHOD PERFORMED BY THE SAME IN WIRELESS COMMUNICATION SYSTEM

(71) Applicant: Samsung Electronics Co., Ltd., Gyeonggi-do (KR)

(72) Inventors: Zhe CHEN, Beijing (CN); Jingxing FU, Beijing (CN); Feifei SUN, Beijing (CN); Bin YU, Beijing (CN)

(21) Appl. No.: 18/399,909

(22) Filed: Dec. 29, 2023

(30) Foreign Application Priority Data
Dec. 29, 2022 (CN) 202211714570.8

(51) Int. Cl. H04W 72/0446; H04W 72/232

(52) U.S. Cl. CPC H04W 72/0446; H04W 72/232

(57) ABSTRACT

Disclosed is a method performed by a network-controlled repeater (NCR) in a wireless communication system, including obtaining NCR configuration information from a network node, and monitoring or detecting a first downlink control information format according to the NCR configuration information, wherein the first downlink control information format is used to inform a beam indication of an access link for the NCR.

### CROSS-REFERENCE TO RELATED APPLICATION(S)

This application is based on and claims priority under 35 U.S.C. § 119(a) to Chinese Patent Application No. 202211714570.8, which was filed in the China National Intellectual Property Administration on Dec. 29, 2022, the entire content of which is incorporated herein by reference.

### BACKGROUND

### 1. Field

The disclosure relates generally to wireless communication, and more specifically, to a method and device for receiving and transmitting information in a wireless communication system.

### 2. Description of the Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) including 28 GHz and 39 GHz. In addition, it has been considered to implement sixth generation (6G) mobile communication technologies (referred to as beyond 5G systems) in terahertz bands (e.g., 95 GHz to 3 terahertz (THz) bands) to accomplish transmission rates fifty times faster than 5G mobile communication technologies and ultra-low latencies one-tenth of 5G mobile communication technologies.

Since the development of 5G mobile communication technologies began, to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in the mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, level 2 (L2) pre-processing, and network slicing for providing a dedicated network specialized to a specific service.

Discussions are ongoing regarding improvement and performance enhancement of initial 5G mobile communication technologies in view of services to be supported by 5G mobile communication technologies. There has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures for new radio (2-step RACH for NR). There also has been ongoing standardization in system architecture/service regarding a 5G service based architecture or service based interface for combining network functions virtualization (NFV) and software-defined networking (SDN) technologies, and mobile edge computing (MEC) for receiving services based on UE positions.

As 5G mobile communication systems are commercialized, it is expected that the number of devices that will be connected to communication networks will exponentially increase. Thus, it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of sixth generation (6G) mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The transmission from a base station to a UE is known as the downlink (DL), and the transmission from a UE to a base station is known as the uplink (UL).

Conventionally, the existing repeater cannot be controlled by a base station. That is, the switch of the repeater, the time and the direction of UL and DL forwarding are all completed by the technology implemented by the repeater itself in a manual setting adjustment, which is an impediment to network distribution flexibility and the coverage of the repeater.

As such, there is a need in the art for a method and apparatus to integrate a terminal device for the repeater (i.e., a network-controlled repeater (NCR)), which can communicate with network devices such as the base station or other network nodes, to more flexibly and efficiently control the repeater as compared to the conventional art.

### SUMMARY

This disclosure has been made to address at least the above-mentioned problems and/or disadvantages and to provide at least the advantages described below.

Accordingly, an aspect of the disclosure is to provide a method and device for receiving and transmitting information/signals, which can improve the performance of the NCR.

An aspect of the disclosure is to provide a method and apparatus by which the NCR can obtain NCR configuration information for the NCR, and monitor and/or detect new DL control information format according to the NCR configuration information to obtain a beam indication of an access link for the NCR, thus improving the reliability of the NCR and further improving the performance of the communication system.

In accordance with an aspect, a method performed by an NCR in a wireless communication system includes obtaining NCR configuration information from a network node, and monitoring or detecting a first downlink control information format according to the NCR configuration information, wherein the first downlink control information format is used to inform a beam indication of an access link for the NCR.

In accordance with an aspect, a method performed by an NCR includes receiving a media access control-control element (MAC-CE) from a network node, and starting or stopping application of beam information indicated by the MAC-CE on a time resource indicated by the MAC-CE, wherein the beam information is used for at least one of downlink forwarding or uplink reception of the NCR, and wherein the MAC-CE is used to notify a beam indication of an access link for the NCR.

In accordance with an aspect, a method performed by an NCR in a wireless communication system includes receiving a media access control-control element (MAC-CE) from a network node, and applying a transmission control indication (TCI) state or a sounding reference signal resource indication (SRI) indicated by the MAC-CE for downlink reception or uplink transmission, wherein the MAC-CE is used to notify a beam indication of a backhaul link for the NCR.

In accordance with an aspect, a method performed by a network node in a wireless communication system includes transmitting a media access control-control element (MAC-CE) to an NCR, and transmitting or receiving a signal, wherein a transmission control indication (TCI) state or a sounding reference signal resource indication (SRI) indicated by the MAC-CE for downlink reception or uplink transmission is applied to the signal, and wherein the MAC-CE is used to notify a beam indication of an access link or a backhaul link for the NCR.

In accordance with an aspect, a method performed by a network node in a wireless communication system includes transmitting NCR configuration information to an NCR, and transmitting a first downlink control information format to the NCR, wherein the NCR configuration information is used for the NCR to monitor or detect the first downlink control information format, and wherein the first downlink control information format is used to notify a beam indication of an access link for the NCR.

### BRIEF DESCRIPTION OF DRAWINGS

The above and other aspects, features and advantages of certain embodiments of the disclosure will be more apparent from the following detailed description taken in conjunction with the accompanying drawings, in which:

FIG. 1 illustrates a structure of a wireless communication network according to an embodiment;

FIG. 2A illustrates a transmission path in a wireless communication network according to an embodiment;

FIG. 2B illustrates a reception path in a wireless communication network according to an embodiment;

FIG. 3A illustrates a structure of a user equipment (UE) in a wireless communication network according to an embodiment;

FIG. 3B illustrates a structure of a base station in a wireless communication network according to an embodiment;

FIG. 4A illustrates an example network including a repeater according to an embodiment;

FIG. 4B illustrates an example structure of an NCR according to an embodiment;

FIG. 5A illustrates a method performed by a repeater according to an embodiment;

FIG. 5B illustrates a method performed by a repeater according to an embodiment;

FIG. 5C illustrates a method performed by a repeater according to an embodiment;

FIG. 5D illustrates a method performed by a repeater according to an embodiment;

FIG. 6A illustrates a method performed by a network device according to an embodiment;

FIG. 6B illustrates a method performed by a network device according to an embodiment;

FIG. 6C illustrates a method performed by a network device according to an embodiment;

FIG. 6D illustrates a method performed by a network device according to an embodiment;

FIG. 7 illustrates a structure of a repeater according to an embodiment; and

FIG. 8 illustrates a structure of a network device according to an embodiment.

### DETAILED DESCRIPTION

Hereinafter, embodiments of the present disclosure will be described in detail with reference to the accompanying drawings. It should be noted that in the drawings, the same or similar elements are denoted by the same or similar reference numerals as far as possible. In addition, detailed descriptions of known functions or configurations that may make the subject matter of the present disclosure unclear will be omitted.

For the same reason, some elements may be exaggerated, omitted or schematically shown in the drawings. In addition, the size of each element does not fully reflect the actual size. In the drawings, the same or corresponding elements have the same reference numerals.

The present disclosure is not limited to the embodiments set forth below, but can be implemented in various forms. The following examples are provided only to fully disclose the present disclosure and to inform those skilled in the art of its scope. Throughout this specification, the same or similar reference numerals indicate the same or similar elements.

In addition, “at least one item/at least one” described in the disclosure includes any and/or all possible combinations of listed items, and various embodiments and examples in embodiments described herein can be changed and combined in any suitable form. In addition, “/” described herein represents “and/or”.

Although this specification includes implementation details, these should not be interpreted as limitations on any invention or the scope of the claimed protection, but as descriptions of specific features of specific embodiments of the disclosure. Some features described in this specification in the context of separate embodiments can also be combined in a single embodiment. On the contrary, various features described in the context of a single embodiment can also be implemented separately in multiple embodiments or in any suitable sub-combination. Although features may be described above as functioning in certain combinations, one or more features from the claimed combination may be deleted from the combination, and the claimed combination may be directed to a subcombination or a variation of a subcombination.

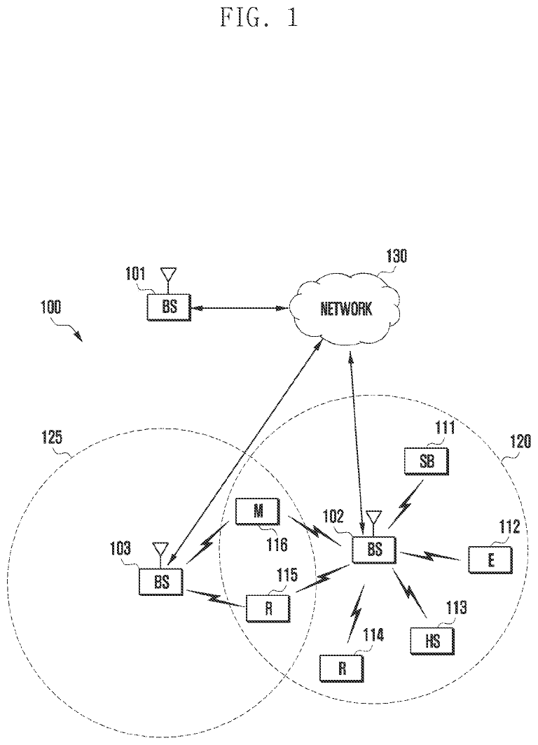

FIG. 1 illustrates a wireless network 100 according to an embodiment.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms such as base station or access point can be used instead of gNodeB or gNB. For convenience, the terms gNodeB and gNB are used herein to refer to network infrastructure components that provide wireless access for remote terminals. Depending on the type of the network, other well-known terms such as mobile station, user station, remote terminal, wireless terminal or user apparatus can be used instead of user equipment or UE, which refer to remote wireless devices that wirelessly access the gNB, no matter whether the UE is a mobile device or a fixed device.

The gNB 102 provides wireless broadband access to the network 130 for a first plurality of UEs within a coverage area 120 of the gNB 102. The first plurality of UEs include a UE 111 which may be located in a small business (SB), a UE 112 which may be located in an enterprise (E), a UE 113 which may be located in a wireless fidelity (WiFi) hotspot (HS), a UE 114 which may be located in a first residence (R), a UE 115 which may be located in a second residence (R), a UE 116 which may be a mobile device (M), such as a cellular phone, a wireless laptop computer, a wireless personal data assistant (PDA), etc. The gNB 103 provides wireless broadband access to network 130 for a second plurality of UEs within its' coverage area 125 of the gNB. The second plurality of UEs include a UE 115 and a UE 116. One or more of the gNBs 101-103 can communicate with each other and with UEs 111-116 using 5G, long term evolution (LTE), LTE-A, or other advanced wireless communication technologies.

The dashed lines show approximate ranges of the coverage areas 120 and 125, and the ranges are shown as approximate circles merely for illustration and explanation purposes. It should be clearly understood that the coverage areas 120, 125 associated with the gNBs may have other shapes, including irregular shapes, depending on configurations of the gNBs and changes in the radio environment associated with natural obstacles and man-made obstacles.

One or more of the gNB 101, gNB 102, and gNB 103 include a two-dimensional (2D) antenna array as described herein and may support codebook designs and structures for systems with 2D antenna arrays.

Although FIG. 1 illustrates an example of the wireless network 100, various changes can be made to FIG. 1. The wireless network 100 can include any number of the gNBs and UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

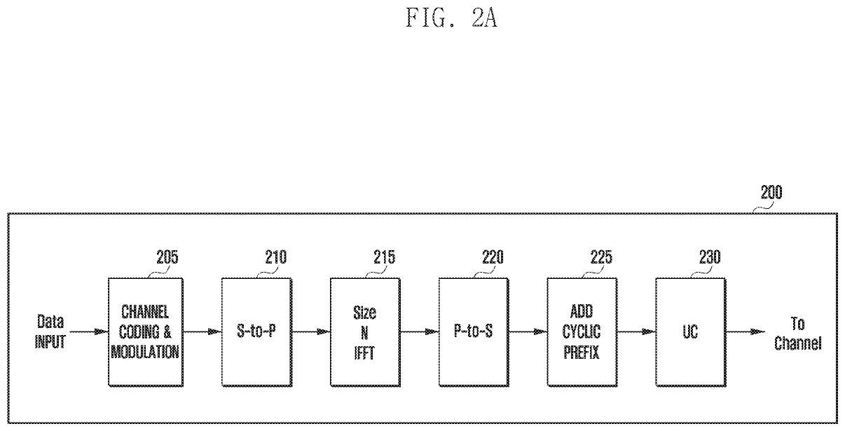

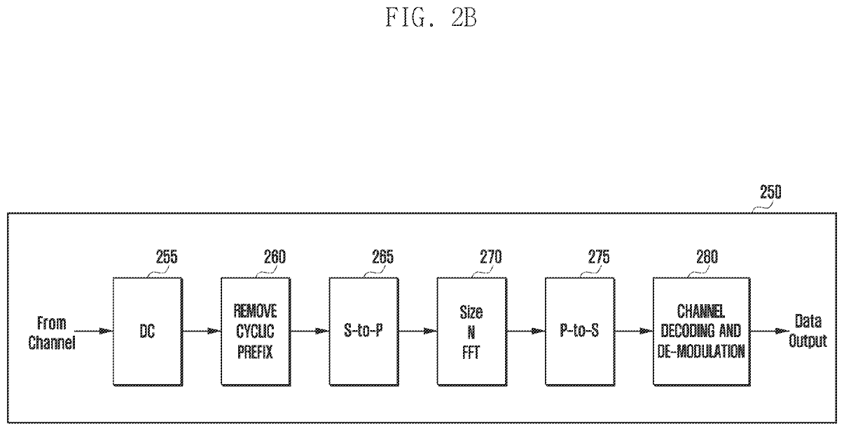

FIGS. 2A and 2B illustrate example wireless transmission and reception paths according to an embodiment. Herein, the transmission path 200 is implemented in a gNB, such as gNB 102, and the reception path 250 is implemented in a UE, such as UE 116. However, the reception path 250 can be implemented in a gNB and the transmission path 200 can be implemented in a UE. The reception path 250 is configured to support codebook designs and structures for systems with 2D antenna arrays as described in embodiments herein.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding such as low density parity check (LDPC) coding), and modulates the input bits such as by using quadrature phase shift keying (QPSK) or quadrature amplitude modulation (QAM)) to generate a sequence of frequency-domain modulated symbols. The S-to-P block 210 converts (such as demultiplexes) serial modulated symbols into parallel data to generate N parallel symbol streams, where N is a size of the IFFT/FFT used in the gNB 102 and UE 116. The size N IFFT block 215 performs IFFT operations on the N parallel symbol streams to generate a time-domain output signal. The P-to-S block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The Size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the DL and may implement a reception path 250 similar to that for receiving from UEs 111-116 in the UL. Similarly, each of UEs 111-116 may implement a transmission path 200 for transmitting to gNBs 101-103 in the UL, and may implement a reception path 250 for receiving from gNBs 101-103 in the DL.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. For DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

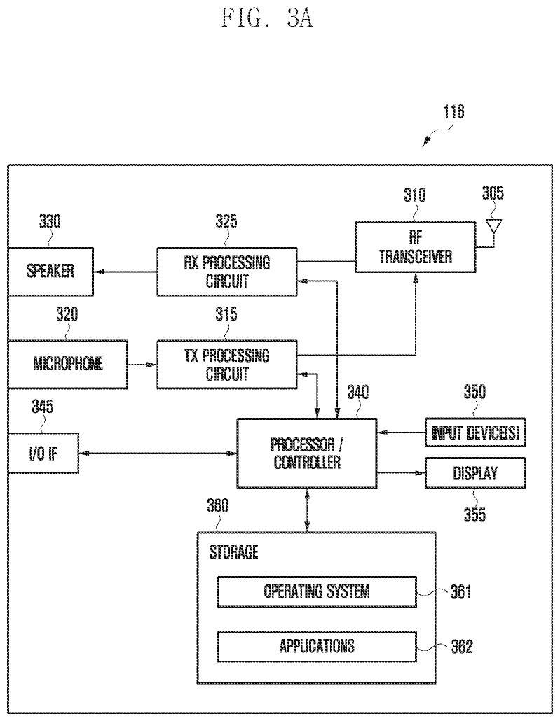

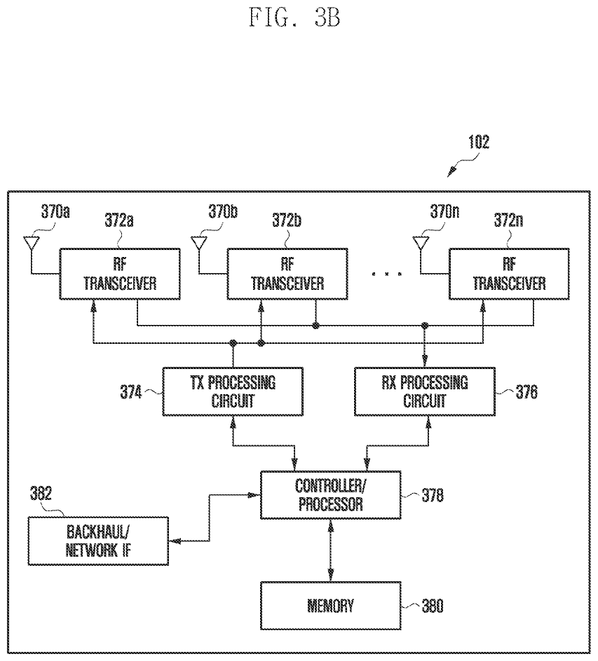

FIG. 3A illustrates an example UE 116 according to an embodiment.

In FIG. 3A, UE 116 includes an antenna 305, a radio frequency (RF) transceiver 310, a transmission (TX) processing circuit 315, a microphone 320, a reception (RX) processing circuit 325, a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. The processor/controller 340 includes at least one microprocessor or microcontroller.

The processor/controller 340 is also capable of executing other processes and programs residing in the memory 360, such as operations for channel quality measurement and reporting for systems with 2D antenna arrays as described herein. The processor/controller 340 can move data into or out of the memory 360 as required by an execution process. The processor/controller 340 is configured to execute the application 362 based on the OS 361 or in response to signals received from the gNB or the operator. The processor/controller 340 is also coupled to an I/O interface 345, which enables the UE 116 to connect to other devices such as laptop computers and handheld computers. 11O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. For example, the processor/controller 340 can be divided into a plurality of processors, such as one or more central processing units (CPUs) and one or more graphics processing units (GPUs). Although FIG. 3A illustrates that the UE 116 is configured as a mobile phone or a smart phone, UEs can be configured to operate as other types of mobile or fixed devices.

FIG. 3B illustrates a structure of a base station in a wireless communication network according to an embodiment.

In FIG. 3B, gNB 102 includes a plurality of antennas 370a-370n, a plurality of RF transceivers 372a-372n, a TX processing circuit 374, and an RX processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in the gNB 102. The controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described herein. The controller/processor 378 supports communication between entities such as web RTCs. The controller/processor 378 can move data into or out of the memory 380 as required by an execution process.

The controller/processor 378 is also coupled to the backhaul or network interface 382 which enables the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include a RAM while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

The transmission and reception paths of the gNB 102 (implemented using RF transceivers 372a-372n, TX processing circuit 374 and/or RX processing circuit 376) support aggregated communication with frequency division duplex (FDD) cells and time division duplex (TDD) cells.

Although FIG. 3B illustrates an example of the gNB 102, various changes may be made to FIG. 3B. For example, gNB 102 can include any number of each component shown in FIG. 3A. For example, the access point can include many backhaul or network interfaces 382, and the controller/processor 378 can support routing functions to route data between different network addresses. Although shown as including a single instance of the TX processing circuit 374 and a single instance of the RX processing circuit 376, gNB 102 can include multiple instances of each (such as one for each RF transceiver).

To enhance the coverage of the 5G wireless communication system, one implementation is to set up a repeater at an edge of a cell or in an area with poor cell signal coverage. Generally, the repeater is usually divided into two sides, a base station side and a terminal side.

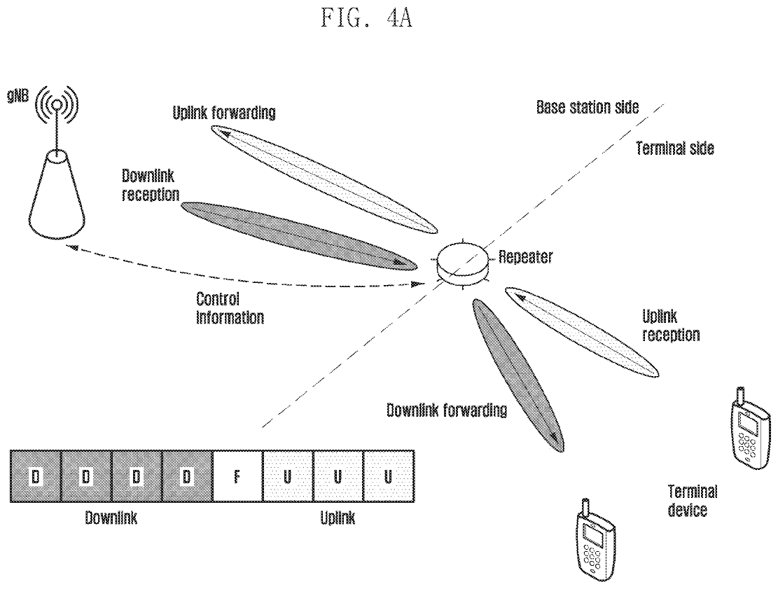

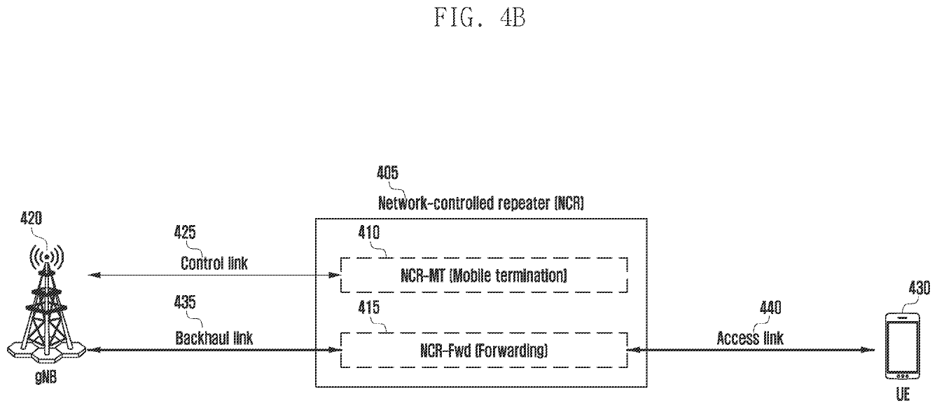

FIG. 4A illustrates an example network including a repeater according to an embodiment.

In FIG. 4A, for a DL of the base station, the repeater receives RF signals from the base station at the base station side. These RF signals pass through a built-in amplifier in the repeater and the amplified signals are transmitted to a terminal device at the terminal side of the repeater. For a UL of the base station, the repeater receives RF signals from the terminal device at the terminal side. These RF signals pass through a built-in amplifier in the repeater and the amplified signals are transmitted to the base station at the base station side of the repeater.

Generally, the existing repeater cannot be controlled by a base station. That is, the switch of the repeater, the time and direction of UL and DL forwarding are all achieved by virtue of the technology implemented by the repeater itself/manual setting adjustment, which is an impediment to the flexibility of network distribution and the coverage of the repeater. To overcome these shortcomings, a solution is to integrate a terminal device for the repeater, which can communicate with network devices (for example, a base station) to flexibly control the repeater, which in this configuration is an NCR.

FIG. 4B illustrates an example structure of an NCR according to an embodiment.

In FIG. 4B, the NCR 405 has a first unit and a second unit. Herein, the NCR 405 and its name are only examples. The first unit is a repeater mobile terminal (NCR-MT) 410, and the second unit is a repeater forwarder (NCR-Fwd) 415, in which the NCR-MT 410 is defined as a functional entity for information/signal exchange (e.g., side control information) with network nodes (e.g., a base station 420). The link between the NCR-MT 410 and the base station 420 is referred to as a control link (C-link) 425. The side control information is at least used to control the NCR-Fwd 415.

The NCR-Fwd 415 is defined as a functional entity for amplifying-and-forwarding radio frequency signals (e.g., uplink/DL RF signals) between a base station 420 and a UE 430. The link between the NCR-Fwd 415 and the base station 420 is referred to as a backhaul link 435 and the link between the NCR-Fwd 415 and the UE 430 is referred to as an access link 440.

The NCR 405 may refer to the NCR-MT 410 or NCR-Fwd 415, or a combination of both. The NCR-MT 410 may also be understood as a UE or a terminal device.

To avoid ambiguity, The corresponding names are defined for the transmitting and/or receiving behaviors of the repeater. In FIG. 4A, for the NCR 405, or for the NCR-Fwd 415, reception of a DL RF signal (or RF signal reception at the base station 420 side, or RF signal reception on the backhaul link 435) is referred to as DL reception; transmission of DL RF signals (or RF signal transmission at the terminal side, RF signal forwarding to the terminal, or RF signal transmission on the access link) is referred to as DL forwarding, reception of UL RF signals (or RF signal reception at the terminal side, or RF signal reception on the access link 440) is referred to as UL reception; transmission of UL RF signal (or RF signal transmission at the base station side, or forwarding of RF signals to the base station, or RF signal transmission on the backhaul link) is referred to as UL forwarding.

For the NCR, it is necessary to obtain the above side control information through corresponding configuration information (e.g., through radio resource control (RRC) signaling) and/or indication information (e.g., through media access control control-control element (MAC-CE) signaling and downlink control information (DCI) signaling). Therefore, it is necessary to enhance the configuration method and indication method related to the side control information.

Disclosed is a series of methods for indicating the NCR, such that the NCR can obtain the side control information accurately, thus improving the reliability of the NCR and further improving the performance of the communication system.

### Embodiment 1

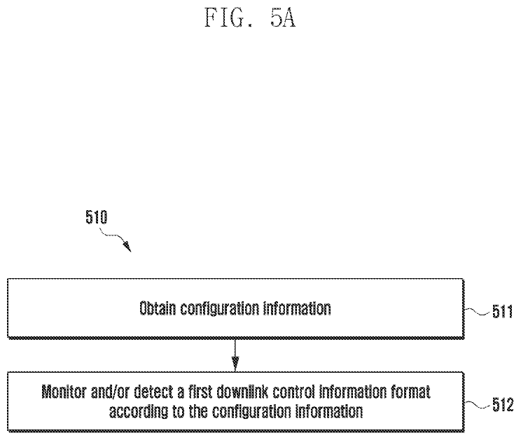

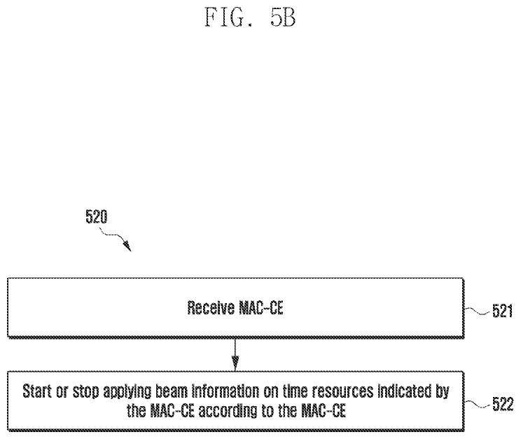

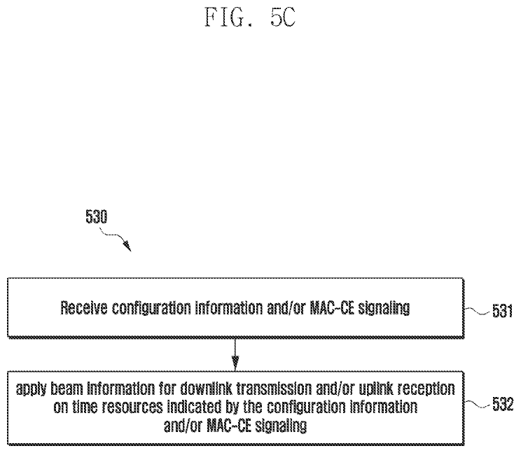

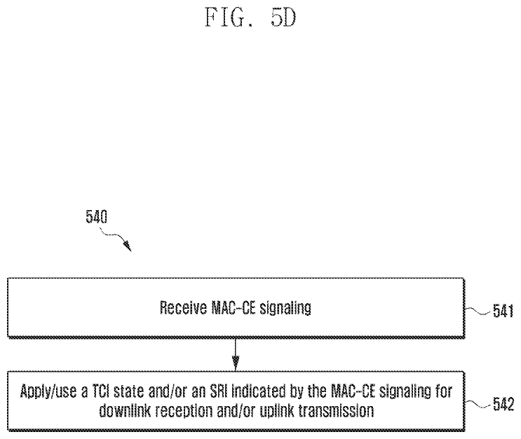

FIG. 5A illustrates a method 510 performed by a repeater according to an embodiment. In step 511, an NCR obtains configuration information from a network device. In step 512, the NCR monitors and/or detects a first DCI format according to the configuration information.

The NCR obtains (for example, receives) the configuration information from the network device. The NCR is, for example, an NCR-MT, and the NCR-MT is used as an example in the following description. The NCR-MT monitors and/or detects the first DCI format (DCI format) according to the configuration information. The configuration information may be carried by RRC signaling.

The first DCI format may be used to notify a beam indication of an access link for the NCR.

The first DCI format may refer to at least one of a DCI format dedicated for the NCR/NCR-Fwd, a DCI format for notifying a beam indication (or access link beam indication) for the NCR/NCR-Fwd, a DCI format carrying the side control information, DCI format 2_x (for example, DCI format 2_8), DCI format 5_x (for example, DCI format 5_0).

In Embodiment 1, a new DCI format (i.e. the first DCI format) is defined for indicating the NCR or the NCR-Fwd. The introduction of the DCI format will not affect configuration and monitoring related to the existing DCI format, thereby improving the compatibility of communication.

After the NCR-MT detects the first DCI format, the NCR/NCR-Fwd forwards on time resources indicated by the first DCI format, or forwards on the time resources indicated by the first DCI format using beam(s)/spatial filter(s) indicated by the first DCI format, or uses beam information (for example, beam index(es)) indicated by the first DCI format on the time resources indicated by the first DCI format.

Herein, monitoring the DCI format (e.g., the first DCI format) may be understood as monitoring physical downlink control channel (PDCCH) candidates of the DCI format (e.g., the first DCI format).

### Example 1

In Example 1, an NCR-MT receives configuration information from a network device; the configuration information includes RNTI information. For example, the RNTI information is a beam indication RNTI (BI-RNTI).

The NCR-MT uses the RNTI information for monitoring and/or detecting of the first DCI format. For example, the NCR-MT determines that a cyclic redundancy check (CRC) of the first DCI format is scrambled by an RNTI indicated by the RNTI information. The description of the first DCI format is provided above and thus will not be repeated here. The first DCI format is monitored in a UE-specific search space (USS) set.

The configuration information may be in a configuration parameter for configuring UE-specific physical downlink control channel (PDCCH) parameters applicable across all bandwidth parts (BWPs) of a serving cell. For example, the configuration parameter is PDCCH-ServingCellConfig. This method places the RNTI configuration information of the first DCI format (for example, a first DCI format monitored in a common search space set) in a UE-specific control information parameter, which maintains the consistency of configuration and avoids the ambiguity of NCR's understanding of the configuration parameter.

The configuration information may be in a configuration parameter for configuring cell-group specific L1 parameters. For example, the configuration parameter is PhysicalCellGroupConfig.

The configuration information may be in a configuration parameter for configuring UE-specific PDCCH parameters or multicast and broadcast service (MBS) multicast PDCCH parameters such as control resource sets (CORESET), search spaces and additional parameters for obtaining the PDCCH. For example, the configuration parameter is PDCCH-Config. This method places the RNTI configuration information of the first DCI format (for example, the first DCI format monitored in the common search space set) in the UE-specific control information parameter, which maintains the consistency of configuration and avoids the ambiguity of NCR's understanding of the configuration parameter.

The configuration information may be in a configuration parameter for configuring a master cell group or secondary cell group. For example, the configuration parameter is CellGroupConfig.

### Example 2

In Example 2, an NCR-MT receives configuration information from a network device. The configuration information includes payload size information. For example, the payload size information is a payload size of a first DCI format.

The NCR-MT uses the payload size information for monitoring and/or detecting of the first DCI format. For example, the NCR-MT monitors and/or detects the first DCI format according to the indicated payload size of the first DCI format. The first DCI format may be monitored in a UE-specific search space set.

The configuration information may be in a configuration parameter for configuring UE-specific PDCCH parameters applicable across all BWPs of a serving cell. For example, the configuration parameter is PDCCH-ServingCellConfig. This method places the payload size information of the first DCI format (for example, a first DCI format monitored in a UE-specific search space set) in a UE-specific control information parameter, which maintains the consistency of configuration and avoids the ambiguity of NCR's understanding of the configuration parameter.

The configuration information may be in a configuration parameter for configuring cell-group specific L1 parameters. For example, the configuration parameter is PhysicalCellGroupConfig.

The configuration information may be in a configuration parameter for configuring UE-specific PDCCH parameters or MBS multicast PDCCH parameters. For example, the configuration parameter is PDCCH-Config. This method places the payload size information of the first DCI format (for example, the first DCI format monitored in the USS set) in the UE-specific control information parameter, which maintains the consistency of configuration and avoids the ambiguity of NCR's understanding of the configuration parameter.

The configuration information may be in a configuration parameter for configuring a master cell group or secondary cell group. For example, the configuration parameter is CellGroupConfig.

### Example 3

In Example 3, an NCR-MT receives configuration information from a network device. The configuration information is used to indicate whether the NCR-MT monitors a first DCI format. The configuration information may be in configuration information of a UE-specific search space set. For example, the UE-specific search space set is configured as a UE-specific type by a search space parameter (for example, SearchSpace in PDCCH-Config with searchSpaceType=ue-Specific).

The NCR-MT monitors the first DCI format according to the configuration information. For example, the NCR-MT monitors the first DCI format in the USS set. Optionally, an RNTI for a CRC of the first DCI format may be obtained according to the method of Example 1. A payload size of the first DCI format may be obtained according to the method of Example 2.

This method reuses the existing UE-specific search space set to monitor the first DCI format without configuring additional search space resources for the first DCI set, thereby reducing the overhead.

### Example 4

In Example 4, an NCR-MT receives configuration information from a network device. The configuration information is used to indicate the NCR-MT to monitor a first DCI format. The configuration information may be in configuration information of a common search space (CSS) set (for example, a Type3-PDCCH CSS set). For example, the common search space set is configured as a common type by a search space parameter (for example, SearchSpace in PDCCH-Config with searchSpaceType=common).

The NCR-MT monitors the first DCI format according to the configuration information. For example, the NCR-MT monitors the first DCI format in the common search space set (for example, the Type3-PDCCH CSS set). Optionally, an RNTI for a CRC of the first DCI format may be obtained according to the method of Example 1. A payload size of the first DCI format may be obtained according to the method of Example 2.

This method reuses the existing common search space set to monitor the first DCI format without configuring additional search space resources for the first DCI set, thereby reducing the signaling overhead. In addition, this method enables the base station to control a plurality of different NCRs using a first DCI format, thereby reducing the transmission overhead at the base station side.

### Example 5

In Example 5, an NCR-MT receives beam configuration information from a network device. For example, the beam configuration information includes a number of beams (or a number of NCR-Fwd access link beams; or a number of NCR-Fwd access link beam candidates; or a number of beams that can be used by an NCR-Fwd access link). In this example, the number of beams is denoted as N_{beam}. The beam configuration information also includes (maximum) beam indices (or (maximum) beam indices of the NCR-Fwd access link beams). In this example, the maximum beam index is denoted as N_{max_index}. The number of beams may be obtained by an NCR through configuration information (for example, by operation administration and maintenance) or predefined (for example, in a case of frequency range 1 (FR1) or in a case that a Quasi Co-Location (QCL) typeD parameter is not provided (to the NCR-MT), N_{beam}=1).

The NCR-MT may receive first time resource configuration information from the network device. The first time resource configuration information is a set of time resource (for example, a list of time resource). The list of time resources is used as an example, which includes M entries. Each entry in the list of time resources includes one or more second time resource configuration information indicated by the list of time resources. A number of the second time resource configuration information of each entry is denoted as Tₘ (m=0, 1, 2, . . . , M−1). For example, To represents a number of second time resource configuration information in the first entry; T1 represents a number of second time resource configuration information in the second entry, and so on. A maximum value of M may be, for example, one of 8, 16, 32, 64 and 128, and a maximum value of Tₘ may be, for example, one of 4, 8 and 16.

The second time resource configuration information includes/is associated with at least one of the following parameters:
time resource index
slot offset
   This parameter may indicate a slot offset between a DCI format and a starting slot of the time resource.
   This parameter may indicate a slot offset between a hybrid automatic repeat request acknowledgement (HARQ-ACK) of the DCI format (or a physical uplink shared channel (PUSCH) or a physical uplink control channel (PUCCH) carrying the HARQ-ACK information of the DCI format) and the starting slot of the time resource.
start symbol and length
   This parameter may indicate an index giving valid combinations of start symbol and length (jointly encoded) as a start and length indicator (SLIV). The network device may configure this parameter so that this time resource does not cross a boundary of a slot.
start symbol
   This parameter may indicate an index of a start symbol of a time resource in a starting slot.

The starting slot of the time resource may be determined according to the above slot offset.
length
   This parameter may indicate a time length of a time resource. For example, this parameter indicates a number of consecutive symbols/slots corresponding to the time resource.
subcarrier spacing
   This parameter may indicate a subcarrier spacing of the time resource.

The NCR-MT determines information/fields in the first DCI format according to the above beam configuration information and/or first time resource configuration information. The information/fields in the first DCI format may be determined according to the above beam configuration information and/or first time resource configuration information. The information/fields in the first DCI format (hereinafter, field) include at least one of:
beam field: beam field #1, beam field #2, . . . , beam field #L.
   This is used to indicate beam indices.
   A number of bits of the beam field (or each of L beam fields) may be determined by the number of beams N_{beam}.
      For example, the number of bits of the beam field is ┌log₂ N_{beam}┐. The number of bits of the field is, for example, one of 0, 1, 2, 3 and 4.
      For example, the number of bits of the beam field is ┌log₂(N_{beam}+1)┐. The number of bits of the field is, for example, one of 0, 1, 2, 3 and 4. A specific code point of the beam field (for example, a lowest code point or code point 0 or all 0s) is used to indicate that the NCR-Fwd is off or does not forward (or to indicate that the NCR-Fwd is off or does not forward on corresponding time resources). Optionally, remaining code points are used to map N_{beam} beam indices (in order).
      For example, the number of bits of the beam field is ┌log₂(N_{beam}+2)┐. The number of bits of the field is, for example, one of 0, 1, 2, 3 and 4. A first specific code point of the beam field (for example, a lowest code point or code point 0 or all 0s) is used to indicate that the NCR-Fwd is off or does not forward (or to indicate that the NCR-Fwd is off or does not forward on corresponding time resources). A second specific code point of the beam field (for example, a lowest code point or code point 1) is used to indicate that the NCR-Fwd is on or forwards (or to indicate that the NCR-Fwd is on or forwards on the corresponding time resources). Remaining code points may be used to map N_{beam} beam indices (in order).
      For example, the number of bits of the beam field is max{┌log₂ N_{beam}┐,1}. The number of bits of the field is, for example, one of 1, 2, 3 and 4. Optionally, when N_{beam}=1, the beam field is set to (or values of the one or more beam fields are all set to 0). Optionally, when N_{beam}=1, the beam field is set to 1 (or the values of the one or more beam fields are all set to 1). This method can ensure that a beam indication field always exists (even if the number of beams is 1), so that a dynamic beam indication can always explicitly indicate the beam indices. Optionally, when the number of beams is 1, the value of the beam field is set to a specific value. The advantage of this method is that the set beam index (for example, 0) can be consistent with an index (for example, 0) explicitly indicated by a periodic beam indication and a semi-persistent beam indication, thereby avoiding ambiguity when the NCR interprets signaling.
      For example, the number of bits of the beam field is max{┌log₂(N_{beam}+1)┐,1}. The number of bits of the field is, for example, one of 1, 2, 3 and 4. A specific code point of the beam field (for example, a lowest code point or code point 0 or all 0s) is used to indicate that the NCR-Fwd is off or does not forward (or to indicate that the NCR-Fwd is off or does not forward on corresponding time resources). Optionally, remaining code points are used to map Nbeam beam indices (in order).
      For example, the number of bits of the beam field is max{┌log₂(N_{beam}+2)┐,1}. The number of bits of the field is, for example, one of 1, 2, 3 and 4. A first specific code point of the beam field (for example, a lowest code point or code point 0 or all 0s) is used to indicate that the NCR-Fwd is off or does not forward (or to indicate that the NCR-Fwd is off or does not forward on corresponding time resources). A second specific code point of the beam field (for example, a lowest code point or code point 1) is used to indicate that the NCR-Fwd is on or forwards (or to indicate that the NCR-Fwd is on or forwards on the corresponding time resources). Optionally, remaining code points are used to map Nbeam beam indices (in order).
   The number of bits of the beam field (or each of L beam fields) may be determined by the maximum beam index N_{index_max}.
      For example, the number of bits of the beam field is ┌log₂ N_{index_max}┐. The number of bits of the field is, for example, one of 0, 1, 2, 3 and 4.
      For example, the number of bits of the beam field is ┌log₂(N_{index_max}+1)┐. The number of bits of the field is, for example, one of 0, 1, 2, 3 and 4.
      For example, the number of bits of the beam field is ┌log₂(N_{index_max}+2)┐. The number of bits of the field is, for example, one of 0, 1, 2, 3 and 4.
      For example, the number of bits of the beam field is max{┌log₂ N_{index_max},┐,1}. The number of bits of the field is, for example, one of 1, 2, 3 and 4.
      For example, the number of bits of the beam field is max{┌log₂(N_{index_max}+1)┐,1}. The number of bits of the field is, for example, one of 1, 2, 3 and 4.
      For example, the number of bits of the beam field is max{┌log₂(N_{index_max}+2)┐,1}. The number of bits of the field is, for example, one of 1, 2, 3 and 4.
   L may be determined according to the first time resource configuration information. For example, L is determined according to a number of time resources (or the second time resource configuration information) of one entry with most time resources (or most second time resource configuration information) among M entries (all entries) in the list of time resources configured by the first time resource configuration information. That is, L=maxₘ₌₀^{M-1}Tₘ.
      In this case, Tₘ time resources indicated by a time resource field apply indications of at most L beam fields in order respectively. As shown below in the Table 1, the first time resource configuration information is configured with M entries (M=4), of which the most entry includes 5 time resources, that is, L=5. For example, when the time resource field indicates the first entry (that is, m=0, including 4 time resources), these four time resources apply beam indication #1, beam indication #2, beam indication #3 and beam indication #4 respectively. For example, when the time resource field indicates the third entry (that is, m=2, including 2 time resources), the two time resources apply beam information indicated by beam field #1 and beam information indicated by beam field #2 respectively.

TABLE 1

| | beam | beam | beam | beam | beam |
|---|---|---|---|---|---|
| m | field #1 | field #2 | field #3 | field #4 | field #5 |
| 0 | time | time | time | time | |
| | resource #1 | resource #2 | resource #3 | resource #4 | |
| 1 | time | time | time | time | time |
| | resource #5 | resource #6 | resource #7 | resource #8 | resource #9 |
| 2 | time | time | | | |
| | resource #10 | resource #11 | | | |
| 3 | time | | | | |
| | resource #12 | | | | |

L may be configured by RRC signaling. For example, the NCR-MT receives the RRC signaling, which is used to indicate a maximum beam value of an NCR-Fwd access link dynamic beam indication. For example, L is equal to the maximum beam value.
   In this case, the network device ensures that L configured by the RRC signaling is greater than or equal to the number of time resources of one entry with most time resources among M entries (all entries) in the list of time resources configured by the first time resource configuration information. That is, L>=maxₘ₌₀^{M-1}Tₘ. In this case, Tₘ time resources indicated by the time resource field apply the indications of at most L beam fields in order respectively. The specific mapping/indication method is provided above.
   Configuration information of L may be in at least one of the following RRC parameters:
      a parameter for configuring UE-specific PDCCH parameters applicable across all bandwidth parts of a serving cell). For example, the parameter is PDCCH-ServingCellConfig.
      a parameter for configuring cell-group specific L1 parameters. For example, the parameter is PhysicalCellGroupConfig.
      a parameter for configuring UE-specific PDCCH parameters or MBS multicast PDCCH parameters such as control resource sets (CORESET), search spaces and additional parameters for obtaining the PDCCH. For example, the parameter is PDCCH-Config.
      The configuration information may be in a parameter for configuring a master cell group (MCG) or secondary cell group (SCG). For example, the parameter is CellGroupConfig.
time resource field
   This field is used to indicate time resources. For example, an entry in the first time resource configuration information (e.g., one of M entries) is indicated. The entry includes/is associated with one or more time resources.
   One or more time resources indicated by the time resource field are associated with one or more beam fields one by one. For example, a beam index indicated by beam field #1 is applied/used in the first time resource indicated by the time resource field; a beam index indicated by beam field #2 is applied/used in the second time resource indicated by the time resource field, and so on.
   A number of bits of the time resource field may be determined by the number M of entries in the first time configuration information (or the list of time resources). For example, the number of bits of the time resource field is ┌log₂ M┐. The number of bits of the field is, for example, one of 0, 1, 2, 3, 4, 5 and 6.
zero-padding bits/reserved bits
   When a payload size of the first DCI format is configured (for example, by the method described in Example 2), if a number of information bits of the first DCI format (for example, the number of bits of the beam field and the number of bits of the time resource field) determined by the beam configuration information and/or the time resource configuration information is smaller than a configured payload size, the first DCI format may include zero-padding bits/reserved bits. That is, a bit size of the first DCI format is equal to the configured payload size by the zero-padding/reserved bits (or zero-padding fields/reserved fields).
   When the information bits of the first DCI format are smaller than a specific DCI format (for example, DCI format 1_0, For example, DCI format 1_0 monitored in a common search space, and DCI format 1_0 monitored in the common search space in the same serving cell), the first DCI format may include zero-padding bits/reserved bits. That is, the bit size of the first DCI format is equal to a payload size of the above DCI format 1_0 by the padding bits/reserved bits (or zero-padding fields/reserved fields).

The above fields (or each of the above fields) may be mapped in the described order. These fields may include the zero-padding fields/padding bits. The first field may be mapped to a lowest order information bit and each field after it is mapped to a higher order information bit.

The most significant bit of each field may be mapped to a lowest order information bit of the field.

The description order of the above beam field (beam field #1, beam field #2, . . . , beam field #L) and time resource field may be exchanged. That is, in the first DCI format, the time resource field is followed by the beam field.

### Example 6

In Example 6, an NCR-MT receives beam configuration information from a network device. The detailed description may refer to Example 5, which will not be repeated here.

The NCR-MT may further receive third time resource configuration information from the network device. The time resource configuration information is a set of time resources (for example, a list of time resources). The list of time resources is used as an example, which includes K entries. A maximum value of K is, for example, one of 4, 8 and 16. Each entry includes a fourth time resource configuration information. A fourth time resource configuration information includes/is associated with at least one of the following parameters:
time resource index
slot offset
   This parameter may indicate a slot offset between DCI and a starting slot of the time resource.
   This parameter may indicate a slot offset between HARQ-ACK of the DCI (or a PUSCH or a PUCCH carrying HARQ-ACK information of the DCI) and the starting slot of the time resource.
start symbol and length
   This parameter may indicate an index giving valid combinations of start symbol and length (jointly encoded) as a start and length indicator (SLIV). The network device may configure this parameter so that this time resource does not cross a boundary of a slot.
start symbol
   This parameter may indicate an index of a start symbol of a time resource in a starting slot. The starting slot of the time resource may be determined according to the above slot offset.
length
   This parameter may indicate a time length of a time resource. For example, this parameter indicates a number of consecutive symbols/slots corresponding to the time resource.
subcarrier spacing
   This parameter may indicate a subcarrier spacing of the time resource.

The NCR-MT may further receive fifth time resource configuration information from the network device. The time resource configuration information is a set of time resources (for example, a list of time resources). The list of time resources is used as an example, which includes M entries. Each entry in the list of time resources includes one or more time resource indices (for example, the indices are used to refer to the fourth time resource configuration information in the third time resource configuration information). The one or more time resource indices may be indicated by a time resource index list. A number of time resource indices of each entry is denoted as Tₘ (m=0, 1, 2, . . . , M−1). For example, To represents a number of time resource indices of the first entry; T₁ represents a number of time resource indices of the second entry, and so on. Optionally, a maximum value of M is, for example, one of 8, 16, 32, 64 and 128. Optionally, a maximum value of Tₘ is, for example, one of 4, 8 and 16.

The NCR-MT determines information/fields in a first DCI format according to the above beam configuration information and/or fifth time resource configuration information. The information/fields in the first DCI format may be determined according to the above beam configuration information and/or fifth time resource configuration information. The description of the first DCI format is provided above, which will not be repeated here. The information/fields in the first DCI format (hereinafter, “field” is used as an example) include at least one of
beam field: beam field #1, beam field #2, . . . , beam field #L.
   The description of the beam field (or each of L beam fields) may refer to Example 5.
   L may be determined according to the fifth time resource configuration information. For example, L is determined according to a number of time resources (or time resource indices) of one entry with most time resources (or most time resource indices) among M entries (all entries) in the list of time resources configured by the fifth time resource configuration information. That is, L=maxₘ₌₀^{M-1}Tₘ.
      In this case, Tₘ time resources indicated by a time resource field apply indications of at most L beam fields in order respectively. As shown below in Table 2, the time resource configuration information is configured with M entries (M=4), of which the most entry includes 5 time resources, that is, L=5. For example, when the time resource field indicates the first entry (that is, m=0, including 4 time resources), these four time resources apply beam #1, beam #2, beam #3 and beam #4 respectively. For example, when the time resource field indicates the third entry (that is, m=2, including 2 time resources), the two time resources apply beam #1 and beam #2 respectively.

TABLE 2

| | beam | beam | beam | beam | beam |
|---|---|---|---|---|---|
| | indication | indication | indication | indication | indication |
| m | #1 | #2 | #3 | #4 | #5 |
| 0 | time | time | time | time | |
| | resource #1 | resource #2 | resource #3 | resource #4 | |
| 1 | time | time | time | time | time |
| | resource #5 | resource #6 | resource #7 | resource #8 | resource #9 |
| 2 | time | time | | | |
| | resource #10 | resource #11 | | | |
| 3 | time | | | | |
| | resource #12 | | | | |

L may be configured by RRC signaling. For example, the NCR-MT receives the RRC signaling, which is used to indicate a maximum beam value of an NCR-Fwd dynamic access link beam indication. For example, L is equal to the maximum value.
   In this case, the network side ensures that L configured by the RRC signaling is greater than or equal to the number of time resources of one entry with most time resources among M entries (all entries) in the list of time resources configured by the fifth time resource configuration information. That is, L>=maxₘ₌₀^{M-1}Tₘ. In this case, Tₘ time resources indicated by the time resource field apply the indications of at most L beam fields in order respectively. The specific mapping/indication method is provided above.
   Configuration information of L may be in at least one of the following RRC parameters:
      a parameter for configuring UE-specific PDCCH parameters applicable across all bandwidth parts of a serving cell). For example, the parameter is PDCCH-ServingCellConfig.
      a parameter for configuring cell-group specific L1 parameters. For example, the parameter is PhysicalCellGroupConfig.
      a parameter for configuring UE-specific PDCCH parameters or MBS multicast PDCCH parameters such as control resource sets (CORESET), search spaces and additional parameters for obtaining the PDCCH. For example, the parameter is PDCCH-Config.
      The configuration information may be in a parameter for configuring a master cell group (MCG) or secondary cell group (SCG). For example, the parameter is CellGroupConfig.
time resource field
   This field is used to indicate time resources. For example, an entry in the third time resource configuration information (e.g., one of M entries) is indicated. The entry includes/is associated with one or more time resources.
   One or more time resources indicated by the time resource field are associated with one or more beam fields one by one. For example, a beam index indicated by beam field #1 is applied/used in the first time resource indicated by the time resource field; a beam index indicated by beam field #2 is applied/used in the second time resource indicated by the time resource field, and so on.
   A number of bits of the time resource field may be determined by the number M of entries in the list of time resources (or set of time resources). For example, the number of bits of the time resource field is ┌log₂ M┐. The number of bits of the field is, for example, one of 0, 1, 2, 3, 4, 5 and 6.
zero-padding bits/reserved bits
   When a payload size of the first DCI format is configured (for example, by the method described in Example 2), if a number of information bits of the first DCI format (for example, the number of bits of the beam field and the number of bits of the time resource field) determined by the beam configuration information and/or the time resource configuration information is smaller than a configured payload size, the first DCI format may include zero-padding bits/reserved bits. That is, a bit size of the first DCI format is equal to the configured payload size by the zero-padding/reserved bits (or zero-padding fields/reserved fields).
   When the information bits of the first DCI format are smaller than a specific DCI format (for example, DCI format 1_0, For example, DCI format 1_0 monitored in a common search space, and DCI format 1_0 monitored in the common search space in the same serving cell), the first DCI format may include zero-padding bits/reserved bits. That is, the bit size of the first DCI format is equal to a payload size of the above DCI format 1_0 by the padding bits/reserved bits (or zero-padding fields/reserved fields).

The above fields (or each of the above fields) may be mapped in the described order. These fields may include the zero-padding fields/padding bits. The first field may be mapped to a lowest order information bit and each field after it is mapped to a higher order information bit.

The most significant bit of each field may be mapped to a lowest order information bit of the field.

The description order of the above beam field (beam field #1, beam field #2, . . . , beam field #L) and time resource field may be exchanged. That is, in the first DCI format, the time resource field is followed by the beam field.

### Example 7

In Example 7, an NCR-MT receives beam configuration information from a network device.

The NCR-MT may further receive sixth time resource configuration information from the network device. The time resource configuration information is a set of time resource (for example, a list of time resource). The list of time resources is used as an example, which includes K entries. Each entry includes a seventh time resource configuration information. That is, the time list includes K time resource configuration information. A seventh time resource configuration information includes/is associated with at least one of the following parameters:
time resource index
slot offset
   This parameter may indicate a slot offset between DCI and a starting slot of the time resource.
   This parameter may indicate a slot offset between HARQ-ACK of the DCI (or a PUSCH or a PUCCH carrying HARQ-ACK information of the DCI) and the starting slot of the time resource.
start symbol and length
   This parameter may indicate an index giving valid combinations of start symbol and length (jointly encoded) as a start and length indicator (SLIV). The network device may configure this parameter so that this time resource does not cross a boundary of a slot.
start symbol
   This parameter may indicate an index of a start symbol of a time resource in a starting slot.

The starting slot of the time resource may be determined according to the above slot offset.
length
   This parameter may indicate a time length of a time resource. For example, this parameter indicates a number of consecutive symbols/slots corresponding to the time resource.
subcarrier spacing
   This parameter may indicate a subcarrier spacing of the time resources.

The NCR-MT determines information/fields in the first DCI format according to the above beam configuration information and/or sixth time resource configuration information. The information/fields in the first DCI format may be determined according to the above beam configuration information and/or the sixth time resource configuration information. The description of the first DCI format is provided above, which will not be repeated here. The information/fields in the first DCI format (hereinafter, “field” is used as an example) include at least one of:
beam field: beam field #1, beam field #2, . . . , beam field #L.
   A first code point (for example, a lowest code point or code point 0 or all 0s) of the beam field (or each of L beam fields) may be used to represent that no beam is indicated. If the NCR-MT detects the first DCI format and one of the beam fields indicates the first code point, the NCR-MT ignores (does not apply) the beam field (and a time resource field associated with/corresponding to the beam field).
   A second code point (for example, a lowest code point or a second lowest code point or a code point different from the first code point) of the beam field (or each of L beam fields) may be used to indicate that the NCR-Fwd is off or does not forward (or to indicate that the NCR-Fwd is off or does not forward on corresponding time resource (indicated by the time resource field).
   A number of bits of the beam indication field (or each of L beam fields) may be determined by a number of beams N_{beam}.
      For example, the number of bits of the beam field is ┌log₂ N_{beam}┐. The number of bits of the field is, for example, one of 0, 1, 2, 3 and 4.
      For example, the number of bits of the beam field is ┌log₂(N_{beam}+1)┐. The number of bits of the field is, for example, one of 0, 1, 2, 3 and 4. The lowest code point (all-0 code point) of the beam field may be the first code point. Optionally, remaining code points may be used to map N_{beam} beam indices (in order).
      For example, the number of bits of the beam field is ┌log₂(N_{beam}+2)┐. The number of bits of the field is, for example, one of 0, 1, 2, 3 and 4. The lowest code point (all-0 code point) of the beam field may be the first code point. The second lowest code point of the beam field may be the second code point. Optionally, remaining code points may be used to map N_{beam} beam indices (in order).
      For example, the number of bits of the beam field is max{┌log₂ N_{beam}┐,1}. The number of bits of the field is, for example, one of 1, 2, 3 and 4.
      For example, the number of bits of the beam field is max{┌log₂(N_{beam}+1)┐,1}. The number of bits of the field is, for example, one of 1, 2, 3 and 4. The lowest code point (all-0 code point) of the beam field may be the first code point. Optionally, remaining code points may be used to map N_{beam} beam indices (in order).
      For example, the number of bits of the beam field is max{┌log₂(N_{beam}+2)┐,1}. The number of bits of the field is, for example, one of 1, 2, 3 and 4. The lowest code point (all-0 code point) of the beam field may be the first code point. The second lowest code point of the beam field may be the second code point. Optionally, remaining code points may be used to map N_{beam} beam indices (in order).
   The number of bits of the beam field (or each of L beam fields) may be determined by the maximum beam index N_{index_max}.
      For example, the number of bits of the beam field is ┌log₂ N_{index_max}┐. The number of bits of the field is, for example, one of 0, 1, 2, 3 and 4.
      For example, the number of bits of the beam field is ┌log₂(N_{index_max}+1)┐. The number of bits of the field is, for example, one of 0, 1, 2, 3 and 4.
      For example, the number of bits of the beam field is ┌log₂(N_{index_max}+2)┐. The number of bits of the field is, for example, one of 0, 1, 2, 3 and 4.
      For example, the number of bits of the beam field is max{┌log₂ N_{index_max}┐,1}. The number of bits of the field is, for example, one of 1, 2, 3 and 4.
      For example, the number of bits of the beam field is max{┌log₂(N_{index_max}+1)┐,1}. The number of bits of the field is, for example, one of 1, 2, 3 and 4.
      For example, the number of bits of the beam field is max{┌log₂(N_{index_max}+2)┐,1}. The number of bits of the field is, for example, one of 1, 2, 3 and 4.
   L may be configured by RRC signaling. For example, the NCR-MT receives the RRC signaling, which is used to indicate a maximum number of beam indications/time resource indications (for example, L) of NCR-Fwd dynamic access link beam indications.
      Configuration information of L may be in at least one of the following RRC parameters:
         a parameter for configuring UE-specific PDCCH parameters applicable across all bandwidth parts of a serving cell). For example, the parameter is PDCCH-ServingCellConfig.
         a parameter for configuring cell-group specific Li parameters. For example, the parameter is PhysicalCellGroupConfig.
         a parameter for configuring UE-specific PDCCH parameters or MBS multicast PDCCH parameters such as control resource sets (CORESET), search spaces and additional parameters for obtaining the PDCCH. For example, the parameter is PDCCH-Config.
         The configuration information may be in a parameter for configuring a master cell group (MCG) or secondary cell group (SCG). For example, the parameter is CellGroupConfig.
   L may be determined according to T. For example, L is equal to T (L=T).
      The beam fields and the time resource fields may be mapped (or associated) one by one. For example, when T=L=4, the beam fields are beam field #1, beam field #2, beam field #3 and beam field #4; and the time resource fields are time resource field #1, time resource field #2, time resource field #3 and time resource field #4. At this time, beam field #1 corresponds to time resource field #1, beam field #2 corresponds to time resource field #2, and so on. The NCR uses a beam index indicated by the beam field on a time resource indicated by the time resource field according to an indication of the beam field and the corresponding time resource field.
time resource field: time resource field #1, time resource field #2, . . . , time resource field #T.
   This field is used to indicate time resources. For example, the (each) time resource field indicates a time resource included in/associated with the sixth time resource configuration information.
   The first time resource indicated by time resource field #1; the second time resource indicated by time resource field #2, and so on.
   The time resource field is associated with the beam field one by one. The beam index indicated by beam field #1 is applied/used in the time resource indicated by time resource field #1; the beam index indicated by beam field #2 is applied/used in the time resource indicated by time resource field #2, and so on.
   A first code point (for example, a lowest code point or code point 0 or all 0s) of the time resource field (or each of T time resource fields) may be used to represent that no time resource is indicated. If the NCR-MT detects the first DCI format and one of the time resource fields indicates the first code point, the NCR-MT ignores (does not apply) the time resource field (and a beam field associated with/corresponding to the time resource field).
   A number of bits of the time resource field (or each of T time resource fields) may be determined by the number K of entries in the sixth time resource configuration information (the number of entries in the list of time resources).
      For example, the number of bits of the time resource field is ┌log₂ K┐. The number of bits of the field is, for example, one of 0, 1, 2, 3 and 4.
      For example, the number of bits of the time resource field is ┌log₂(K+1)┐. The number of bits of the field is, for example, one of 0, 1, 2, 3 and 4. The lowest code point (all-0 code point) of the time resource field may be the first code point. Optionally, remaining code points are used to map K time resource entries (in order).
      For example, the number of bits of the time resource field is max{┌log₂ K┐,1}. The number of bits of the field is, for example, one of 1, 2, 3 and 4.
      For example, the number of bits of the time resource field is max{┌log₂(K+1)┐,1}. The number of bits of the field is, for example, one of 1, 2, 3 and 4. The lowest code point (all-0 code point) of the time resource field may be the first code point. Optionally, remaining code points are used to map K time resource entries (in order).
   T may be configured by RRC signaling. For example, the NCR-MT receives the RRC signaling, which is used to indicate a maximum number of time resource indications/beam indications (for example, T) of NCR-Fwd dynamic access link beam indications.
      Configuration information of T may be in at least one of the following RRC parameters:
         a parameter for configuring UE-specific PDCCH parameters applicable across all bandwidth parts of a serving cell). For example, the parameter is PDCCH-ServingCellConfig.
         a parameter for configuring cell-group specific L1 parameters. For example, the parameter is PhysicalCellGroupConfig.
         a parameter for configuring UE-specific PDCCH parameters or MBS multicast PDCCH parameters such as control resource sets (CORESET), search spaces and additional parameters for obtaining the PDCCH. For example, the parameter is PDCCH-Config.
         The configuration information may be in a parameter for configuring a master cell group (MCG) or secondary cell group (SCG). For example, the parameter is CellGroupConfig.
   T may be determined according to L. For example, T is equal to L (T=L).
      In this case, the beam fields and the time resource fields are mapped (or associated) one by one. For example, when T=L=4, the beam fields are beam field #1, beam field #2, beam field #3 and beam field #4; and the time resource fields are time resource field #1, time resource field #2, time resource field #3 and time resource field #4. At this time, beam field #1 corresponds to time resource field #1, beam field #2 corresponds to time resource field #2, and so on. The NCR uses a beam indicated by the beam field on a time resource indicated by the time resource field according to an indication of the beam field and the corresponding time resource field.
zero-padding bits/reserved bits
   When a payload size of the first DCI format is configured (for example, by the method described in Example 2), if a number of information bits of the first DCI format (for example, the number of bits of the beam field and the number of bits of the time resource field) determined by the beam configuration information and/or the time resource configuration information is smaller than a configured payload size, the first DCI format may include zero-padding bits/reserved bits. That is, a bit size of the first DCI format is equal to the configured payload size by the zero-padding/reserved bits (or zero-padding fields/reserved fields).
   When the information bits of the first DCI format are smaller than a specific DCI format (for example, DCI format 1_0, For example, DCI format 1_0 monitored in a common search space, and For example, DCI format 1_0 monitored in the common search space in the same serving cell), the first DCI format may include zero-padding bits/reserved bits. That is, the bit size of the first DCI format is equal to a payload size of the above DCI format 1_0 by the padding bits/reserved bits (or zero-padding fields/reserved fields).

If a resource (e.g., a symbol/slot/subframe) is included in time resources indicated by more than one/a plurality of time resource fields (or if the time resources indicated by more than one/a plurality of time resource fields are not time-division multiplexed), values of the corresponding beam fields (or corresponding to these time resource fields) may be the same.

If values indicated by more than one/a plurality of time resource fields are the same, the values of the corresponding beam fields (or corresponding to these time resource fields) may be the same.

If two time resources indicated by two time resource fields are not time-division multiplexed (TDMed), values of beam fields corresponding to the two time resource fields may be the same.

If values indicated by two beam fields are different, time resources corresponding to the two beam fields (indicated by time resource fields) may not be time-division multiplexed (TDMed).

If values indicated by more than one/a plurality of beam fields are the same, values of time resource fields corresponding to these beam fields may be also the same.

If the NCR (for example, the NCR-MT) receives/detects one or more first DCI formats indicating multiple time resources and these time resources include the same slots or symbols (or these time resources are not time-division multiplexed), beam indices (or values of beam fields) corresponding to these time resources are the same (or the NCR determines that values of beam indications corresponding to these time resources are the same).

Herein, not time-division multiplexed may be understood as overlapping in time, the beam field is equivalent to a beam indication field, and also equivalent to a beam index field, the time resource field is equivalent to a time resource indication field, and also equivalent to a time resource index field, and the time resource may also be understood as a time-domain resource.

The above fields (or each of the above fields) may be mapped in the described order. These fields may include the zero-padding fields/padding bits. The first field may be mapped to a lowest order information bit and each field after it may be mapped to a higher order information bit.

The most significant bit of each field may be mapped to a lowest order information bit of the field.

The description order of the above beam field (beam field #1, beam field #2, . . . , beam field #L) and time resource field (time resource field #1, time resource field #2, . . . , time resource field #T) may be exchanged. That is, in the first DCI format, the time resource field is followed by the beam field.

The above method is further described by a specific example. The NCR-MT receives beam configuration information from the network device. A number of configured beams is denoted as 8. The NCR-MT further receives time resource configuration information from the network device. A number/number of entries of time resource configurations is 16. The NCR-MT further receives configuration information of a number of dynamic beam indications (the number is 5, that is, L=4) from the network device.

The NCR-MT monitors a first DCI format according to any combination of the above three configuration information. A lowest code point of a beam field is a first code point, that is, it is used to represent that no beam is indicated. Thus, a size of the beam field (which may also be called a bit width of the field) is log₂(8+1) rounded up to 4 bits. In addition, according to the number of entries in the time resource configuration information, it can be known that a size of the time resource field is also 4 bits. Thus, the first DCI format includes the following fields:
beam field #1 (4 bits), beam field #2 (4 bits), beam field #3 (4 bits), and beam field #4 (4 bits); and
time resource field #1 (4 bits), time resource field #2 (4 bits), time resource field #3 (4 bits) and time resource field #4 (4 bits).

When the NCR-MT detects the first DCI format, it includes the contents shown below in Table 3.

TABLE 3

| beam field #1 | beam field #2 | beam field #3 | beam field #4 |
|---|---|---|---|
| ‘0101’ | ‘0000’ | ‘0011’ | ‘0100’ |
| time resource | time resource | time resource | time resource |
| field #1 | field #2 | field #3 | field #4 |
| ‘0011’ | ‘0000’ | ‘0111’ | ‘0101’ |

According to Table 3, in the first DCI format:
beam field #1 indicates beam index #4 (it should be noted that a lowest beam index is 0), and time resource field #1 corresponding to beam field #1 indicates time resource #3. Thus, the NCR-Fwd performs (downlink forwarding or uplink reception) on time resource #3 using a spatial filter associated with beam index #4.
beam field #2 represents that no beam is indicated, and the NCR ignores beam field #2 and/or time resource field #2 (corresponding to beam field #2).
beam field #3 indicates beam index #2 (it should be noted that the smallest beam index is 0), and time resource field #3 corresponding to beam field #3 indicates time resource #7. Thus, the NCR-Fwd performs (downlink forwarding or uplink reception) on time resource #7 using a spatial filter associated with beam index #2.
beam field #4 indicates beam index #3 (it should be noted that the smallest beam index is 0), and time resource field #4 corresponding to beam field #4 indicates time resource #5. Thus, the NCR-Fwd performs (downlink forwarding or uplink reception) on time resource #5 using a spatial filter associated with beam index #3.

For Examples 5-7,
if the NCR-MT detects one or more first DCI formats, and the one or more DCI formats indicate more than one time resource, and the more than one time resource includes the same time resource (for example, at least one slot/symbol/subframe), then the more than one time resource satisfies at least one of the following conditions:
values of beam indices corresponding to the more than one time resource are the same (a corresponding relationship between the time resources and the beam indices may refer to the description of Examples 5-7);
a beam index corresponding to the same time resource included in the more than one time resource is determined according to the last one (e.g., the last one in time-domain) of the one or more first DCI formats.

Optionally, an interval between (the last symbol of) a PDCCH corresponding to the one or more first DCI formats and the time resource (for example, at least one symbol) may be greater than or equal to a beam application time. The beam application time refers to a time from receiving the first DCI format to applying a beam indication carried by the first DCI format (for example, a shortest time from receiving the first DCI format to applying the beam indication carried by the first DCI format).

Methods 1-3 in the above Examples 5-7 provide a method for handling dynamic beam indication conflicts, which avoids ambiguity when the NCR interprets one or more DCI formats, thereby improving the reliability of the system.

### Example 8

Example 8 is a variation/supplement of Example 5. An NCR-MT receives first time resource configuration information from a network device. The first time resource configuration information is a set of time resources (for example, a list of time resources). The list of time resources is used as an example, which includes M entries. Each entry in the list of time resources includes one or more second time resource configuration information, and each entry in the list of time resources further includes SCS configuration information. The one or more second time resource configuration information and the SCS configuration information satisfy at least one of the following conditions:
If the SCS configuration information is configured (or explicitly configured), SCSs of one or more second time resource configuration information included in this entry are determined according to the configured SCS.
If the SCS configuration information is not configured (or is not explicitly configured, or is implicitly configured), the SCSs of one or more second time resource configuration information included in this entry are determined according to an SCS of the NCR-MT/NCR-Fwd. The SCS of the NCR-MT may refer to an SCS of an active BWP of a cell in which the first DCI format is received. The SCS of the NCR-Fwd may refer to a reference SCS. The reference SCS may be configured according to RRC signaling.

One of the above second time resource configuration information includes/is associated with at least one of the following parameters:
slot offset
   This parameter may indicate a slot offset between DCI and a starting slot of the time resource.
   This parameter may indicate a slot offset between HARQ-ACK of the DCI (or a PUSCH or a PUCCH carrying HARQ-ACK information of the DCI) and the starting slot of the time resource.
   An SCS of the slot offset may be determined according to the above SCS configuration information.
start symbol and length
   This parameter may indicate an index giving valid combinations of start symbol and length (jointly encoded) as a start and length indicator (SLIV). The network device may configure this parameter so that this time resource does not cross a boundary of a slot.
   An SCS of the start symbol and length may be determined according to the above SCS configuration information.
start symbol
   This parameter may indicate an index of a start symbol of a time resource in a starting slot. The starting slot of the time resource may be determined according to the above slot offset.
   An SCS of the start symbol may be determined according to the above SCS configuration information.
length
   This parameter may indicate a time length of a time resource. For example, this parameter indicates a number of consecutive symbols/slots corresponding to the time resource.
   An SCS of the length (time length) may be determined according to the above SCS configuration information.

This example provides a method for configuring the subcarrier spacing of time resources for NCR forwarding, which is helpful for the time resources indicated by the first DCI format to use the specifically configured carrier spacing, so as to adapt to the subcarrier requirements of system scheduling, thereby improving the flexibility of communication system scheduling.

### Example 9

Example 9 is a variation/supplement of Example 6. An NCR-MT receives fifth time resource configuration information from a network device. The time resource configuration information is a set of time resources (for example, a list of time resources). The list of time resources is used as an example, which includes M entries. Each entry in the list of time resources includes one or more time resource indices. (For example, the index is used to refer to fourth time resource configuration information in third time resource configuration information). The one or more time resource indices may be indicated by a time resource index list. Moreover, each entry in the list of time resources further includes SCS configuration information. The relationship between the one or more time resource configuration information and the SCS configuration information is at least one of
If the SCS configuration information is configured (or explicitly configured), SCSs of one or more time resource configuration information included in this entry is determined according to the configured SCS.
If the SCS configuration information is not configured (or is not explicitly configured, or is implicitly configured), the SCSs of one or more time resource configuration information included in this entry are determined according to an SCS of the NCR-MT/NCR-Fwd. The SCS of the NCR-MT may refer to an SCS of an active BWP of a cell in which the first DCI format is received. The SCS of the NCR-Fwd may refer to a reference SCS. The reference SCS may be configured according to RRC signaling.

One of the above time resource configuration information includes/is associated with at least one of the following parameters:
slot offset
   This parameter may indicate a slot offset between DCI and a starting slot of the time resource.
   This parameter may indicate a slot offset between HARQ-ACK of the DCI (or a PUSCH or a PUCCH carrying HARQ-ACK information of the DCI) and the starting slot of the time resource.
   An SCS of the slot offset may be determined according to the above SCS configuration information.
start symbol and length
   This parameter may indicate an index giving valid combinations of start symbol and length (jointly encoded) as a start and length indicator (SLIV). The network device may configure this parameter so that this time resource does not cross a boundary of a slot.
   An SCS of the start symbol and length may be determined according to the above SCS configuration information.
start symbol
   This parameter may indicate an index of a start symbol of a time resource in a starting slot. The starting slot of the time resource may be determined according to the above slot offset.
   An SCS of the start symbol may be determined according to the above SCS configuration information.
length
   This parameter may indicate a time length of a time resource. For example, this parameter indicates a number of consecutive symbols/slots corresponding to the time resource.
   An SCS of the length (time length) may be determined according to the above SCS configuration information.

This example provides a method for configuring the subcarrier spacing of time resources for NCR forwarding, which is helpful for the time resources indicated by the first DCI format each time to correspond to different subcarrier spacings, thereby improving the flexibility of communication system scheduling.

### Example 10

Example 10 is a variation/supplement of Example 7. An NCR-MT receives sixth time resource configuration information from a network device. The time resource configuration information is a set of time resources (for example, a list of time resources). The list of time resources is used as an example, which includes M entries. Each entry in the list of time resources includes one or more seventh time resource configuration information. The sixth time resource configuration information may further include SCS configuration information. One or more time resource configuration information of each entry in the sixth time resource configuration parameter is applicable to the SCS configuration information. That is, all time resource configuration information in the sixth time resource configuration parameter is determined according to the SCS configuration.

For example, if the SCS configuration information is configured (or explicitly configured), SCS of the time resource configuration information are determined according to the configured SCS.

For example, if the SCS configuration information is not configured (or is not explicitly configured, or is implicitly configured), the SCSs of the time resource configuration information are determined according to an SCS of the NCR-MT/NCR-Fwd. The SCS of the NCR-MT may refer to an SCS of an active BWP of a cell in which the first DCI format is received. The SCS of the NCR-Fwd may refer to a reference SCS. The reference SCS may be configured according to RRC signaling.

One of the seventh time resource configuration information includes/is associated with at least one of the following parameters:
slot offset
   This parameter may indicate a slot offset between DCI and a starting slot of the time resource.
   This parameter may indicate a slot offset between HARQ-ACK of the DCI (or a PUSCH or a PUCCH carrying HARQ-ACK information of the DCI) and the starting slot of the time resource.
   An SCS of the slot offset may be determined according to the above SCS configuration information.
start symbol and length
   This parameter may indicate an index giving valid combinations of start symbol and length (jointly encoded) as a start and length indicator (SLIV). The network device may configure this parameter so that this time resource does not cross a boundary of a slot.
   An SCS of the start symbol and length may be determined according to the above SCS configuration information.
Start symbol
   This parameter may indicate an index of a start symbol of a time resource in a starting slot. The starting slot of the time resource may be determined according to the above slot offset.
   An SCS of the start symbol may be determined according to the above SCS configuration information.
length
   This parameter may indicate a time length of a time resource. For example, this parameter indicates a number of consecutive symbols/slots corresponding to the time resource.
   An SCS of the length (time length) may be determined according to the above SCS configuration information.

This example provides a method for configuring the subcarrier spacing of time resources for NCR forwarding, which is helpful for the time resources indicated by the first DCI format to use the specifically configured carrier spacing, so as to adapt to the subcarrier requirements of system scheduling, thereby improving the flexibility of communication system scheduling.

In Examples 5 to 10, the beam configuration information is carried by RRC signaling. The configuration information may be in one of the following parameters:
a parameter for configuring UE-specific PDCCH parameters applicable across all bandwidth parts of a serving cell). For example, the parameter is PDCCH-ServingCellConfig.
a parameter for configuring cell-group specific L1 parameters. For example, the parameter is PhysicalCellGroupConfig.
a parameter for configuring UE-specific PDCCH parameters or MBS multicast PDCCH parameters such as control resource sets (CORESET), search spaces and additional parameters for obtaining the PDCCH. For example, the parameter is PDCCH-Config.
a parameter for configuring a master cell group (MCG) or secondary cell group (SCG). For example, the parameter is CellGroupConfig.

In Examples 5 to 10, the time resource configuration information (the first time resource configuration information, For example, the fifth time resource configuration information, and For example, the sixth time resource configuration information) is carried by RRC signaling. The configuration information may be in one of the following parameters:
a parameter for configuring UE-specific PDCCH parameters applicable across all bandwidth parts of a serving cell). For example, the parameter is PDCCH-ServingCellConfig.
a parameter for configuring cell-group specific L1 parameters. For example, the parameter is PhysicalCellGroupConfig.
a parameter for configuring UE-specific PDCCH parameters or MBS multicast PDCCH parameters such as control resource sets (CORESET), search spaces and additional parameters for obtaining the PDCCH. For example, the parameter is PDCCH-Config.
a parameter for configuring a master cell group (MCG) or secondary cell group (SCG). For example, the parameter is CellGroupConfig.

### Example 11

In Example 11, an NCR obtains configuration information from a network device. The configuration information includes at least one of the configuration information described in Examples 1-10.

The NCR monitors a first DCI format according to the configuration information. The information/fields in the first DCI format (hereinafter, “field” is used as an example) include at least one of:
a PUCCH resource indicator
   A size of the field may be 3.
HARQ feedback timing indicator
   A size of the field may be predefined (for example, 3). A value of the field may be mapped to {1, 2, 3, 4, 5, 6, 7, 8}.
   The size of the field may be determined by a first HARQ configuration parameter (for example, dl-DataToUL-ACK) that provides a list of timing for given PDSCH to the DL ACK. The first HARQ configuration parameter may be used for DCI format 1_1. The size of the field may be determined by a number (I_0) of entries in the list. For example, the size of the field is log₂ I rounded up. The value of the field is mapped to values provided by the list.
   The size of the field may be determined by a second HARQ configuration parameter (for example, dl-NCR-DCI-ToUL-ACK) that provides a list of timing for the first DCI format to the DL ACK. The second HARQ configuration parameter may be used for the first DCI format. The size of the field may be determined by a number (J) of entries in the list. For example, the size of the field is log 2J rounded up. The value of the field is mapped to values provided by the list.
   The above method may be combined with:
      When the NCR-MT is configured with the first HARQ configuration parameter, the size of the field may be determined by the first HARQ configuration parameter (for example, dl-DataToUL-ACK) that provides a list of timing for given PDSCH to the DL ACK. The first HARQ configuration parameter may be used for DCI format 1_1. The size of the field may be determined by a number (I_0) of entries in the list. For example, the size of the field is log₂ I rounded up. The value of the field is mapped to values provided by the list; when the first HARQ configuration parameter is not configured, the size of the field is 3. The value of the field is mapped to {1, 2, 3, 4, 5, 6, 7, 8}.
      When the NCR-MT is configured with the second HARQ configuration parameter, the size of the field may be determined by the second HARQ configuration parameter (for example, dl-NCR-DCI-ToUL-ACK) that provides a list of timing for the first DCI format to the DL ACK. The second HARQ configuration parameter may be used for the first DCI format. The size of the field may be determined by a number (J) of entries in the list. For example, the size of the field is log₂ J rounded up. The value of the field is mapped to values provided by the list; when the NCR-MT is not configured with the second HARQ configuration parameter, the size of the field is 3. The value of the field is mapped to {1, 2, 3, 4, 5, 6, 7, 8}.
   When the NCR-MT is configured with a HARQ enabling parameter, this field may be determined according to the above method; otherwise, this field is not present.

When the NCR-MT is configured with the HARQ enabling parameter, the NCR-MT may perform the behaviors described below (for example, a method for determining PUCCH resources, a method for determining HARQ-ACK feedback timings, and a method for processing HARQ-ACK feedback multiplexing described below). Otherwise, when the NCR-MT is configured with HARQ disabling, when the NCR-MT detects/receives the first DCI format, the NCR-MT does not generate HARQ-ACK information corresponding to the first DCI format.

When the NCR-MT detects/receives the first DCI format, it may determine physical uplink control channel (PUCCH) resources according to the PUCCH resource indicator. The physical uplink control channel resources are used to carry HARQ-ACK information (or, for the HARQ-ACK information of the first DCI format). For a mapping relationship between values of the PUCCH resource indicator and PUCCH resource indices, the description of the case that the PUCCH resource indicator is 3 bits in the existing standard may be referred to.

When the NCR-MT detects/receives the first DCI format, it determines PUCCH resources according to PUCCH resource configuration information. The PUCCH resources are PUCCH resources for configuring HARQ information carrying the first DCI format. The PUCCH resource configuration information may include only one PUCCH resource. The PUCCH resource format may be PUCCH format 0 or PUCCH format 1.

When the NCR-MT detects/receives the first DCI format (for example, the first DCI format generates HARQ-ACK information bits but does not schedule the PDSCH) and the first DCI format ends in downlink slot n_D, the NCR-MT provides corresponding HARQ-ACK information in a PUCCH transmission in uplink slot n+k. k is a number of slots, and if the HARQ feedback timing indicator exists, the number of slots is indicated by the HARQ feedback timing indicator; optionally, if the HARQ feedback timing indicator does not exist, the number of slots is provided by the first HARQ configuration parameter or the second HARQ configuration parameter. The slot n refers to the last uplink slot that overlaps with downlink slot n_D. The UL slot may be used for the PUCCH transmission.

The NCR-MT does not expect to detect/receive at least two first DCI formats, where the at least two first DCI formats feed back corresponding HARQ-ACK information in the same slot (for example, uplink slot).

The NCR-MT (expects to) detects/receives two first DCI formats, where the two first DCI formats feed back corresponding HARQ-ACK information in different slots (for example, uplink slots).

If the NCR-MT detects two first DCI formats, the HARQ-ACK feedback information corresponding to the two first DCI formats is in different slots (for example, uplink slots) respectively. The NCR-MT may feed back the HARQ-ACK feedback information corresponding to the two first DCI formats in different slots.

When the NCR-MT detects/receives at least two first DCI formats, and the HARQ-ACK feedback information corresponding to the at least two first DCI formats is in the same slot (for example, uplink slot), the NCR-MT generates (or transmits; or only generates) HARQ-ACK information corresponding to the last one (for example, the last one in time-domain) of the at least two first DCI formats. The NCR-MT does not generate (or discards; or does not transmit) HARQ-ACK information corresponding to other DCI formats (DCI formats other than the last first DCI format among the at least two first DCI formats).

If the NCR-MT detects/receives a first DCI format and a second DCI format (for example, a DCI format other than the first DCI format), HARQ-ACK information corresponding to the first DCI format and the second DCI format is in different slots respectively.

When the NCR-MT detects/receives a first DCI format and a second DCI format (for example, a DCI format other than the first DCI format) and the HARQ-ACK information corresponding to the first DCI format and the second DCI format is in the same UL slot, the NCR-MT does not multiplex the HARQ-ACK information corresponding to the first DCI format and the HARQ-ACK information corresponding to the second DCI format.

When the NCR-MT detects/receives a first DCI format and a second DCI format (for example, a DCI format other than the first DCI format) and the HARQ-ACK feedback information corresponding to the first DCI format and the second DCI format is in the same UL slot, the NCR-MT does not generate (or discards, or does not transmit) the HARQ-ACK information corresponding to the first DCI format, or the NCR-MT does not generate (or discards, or does not transmit) the HARQ-ACK information corresponding to the second DCI format.

When the NCR-MT detects/receives a first DCI format and a second DCI format (for example, a DCI format other than the first DCI format) and the HARQ-ACK feedback information corresponding to the first DCI format and the second DCI format is in the same slot (for example, uplink slot), the NCR-MT generates (or transmits, or only generates) the HARQ-ACK information corresponding to the first DCI format, or the NCR-MT generates (or transmits, or only generates) the HARQ-ACK information corresponding to the second DCI format.

The above example provides a method for the NCR to process the HARQ-ACK feedback in the first DCI format. This method can handle the conflicts between HARQ-ACK feedbacks, thereby avoiding the unclear NCR behaviors and further improving the reliability of the communication system.

Embodiment 1 provides a method for dynamic beam indicating using the DCI format, which is helpful for the NCR to forward dynamic signals from a base station in a specific direction, thereby improving the indicating efficiency and improving the performance of the communication system.

### Embodiment 2

FIG. 5B illustrates a method 520 performed by a repeater according to an embodiment. In step 521, an NCR receives a MAC-CE from a network device; the MAC-CE refers to at least one of:
a MAC-CE of an access link beam indication;
a MAC-CE of a semi-persistent access link beam indication;
a MAC-CE for notifying a beam indication of an NCR-Fwd access link; and
a MAC-CE for carrying side control information.

In 522, after the NCR receives the MAC-CE, the NCR starts or stops using corresponding beam information on time resources indicated by the MAC-CE according to the MAC-CE. The beam information may be used for NCR-Fwd forwarding (for example, downlink forwarding and/or uplink reception). The beam information may be used for an NCR-Fwd access link.

### Example 1

In Example 1, a MAC-CE activates or deactivates time resources for NCR-Fwd forwarding (for example, downlink transmission or uplink reception). When the MAC-CE activates the time resources, the MAC-CE also indicates beam information (for example, beam indices) used by an NCR-Fwd on the time resources.

In an implementation, an NCR-MT receives thirteenth time resource configuration information from a network device. The time resource configuration information is a set of time resources (for example, a list of time resources). The list of time resources is used as an example, which includes K entries. Each entry includes a fourteenth time resource configuration information. That is, the time list includes K fourteenth time resource configuration information.

The thirteenth time resource configuration information may further include SCS configuration information (for example, a reference SCS), and an SCS of the fourteenth time resource configuration information associated with/included in the thirteenth time resource configuration information is determined by the SCS configuration. The thirteenth time resource configuration information may further include periodicity information. A periodicity of (all) the fourteenth time resource configuration information associated with/included in the thirteenth time resource configuration information is determined by the periodicity information.

The fourteenth time resource configuration information includes/is associated with at least one of the following parameters:
time resource index
slot offset
   This parameter may indicate a location (or offset) of a starting slot of the time resource in a period. The period may be indicated by the above periodicity information.
start symbol and length
   This parameter may indicate an index giving valid combinations of start symbol and length (jointly encoded) as a start and length indicator (SLIV). The network device may configure this parameter so that this time resource does not cross a boundary of a slot.
start symbol
   This parameter may indicate an index of a start symbol of a time resource in a starting slot. The starting slot of the time resource may be determined according to the above slot offset.
length
   This parameter may indicate a time length of a time resource. For example, this parameter indicates a number of consecutive symbols/slots corresponding to the time resource.

The NCR-MT further receives MAC-CE signaling from the network device. Information/fields of the MAC-CE signaling (determined by the NCR, or determined by the NCR according to an LCID of the MAC-CE) (hereinafter, “field” is used as an example) include at least one of
number field
   This field is used to indicate a number of beams (or beam indications; or beam indices for an NCR-Fwd access link) and/or time resources included in this MAC-CE.
   A size of the field may be predefined (for example, 2, 4 or 8 bits).
activation or deactivation field
   This field indicates whether to activate or deactivate the indicated time resources (for example, (all) time resources indicated by this MAC-CE, or time resources indicated by all time resource fields). For example, “0” represents deactivation; “1” represents activation.
   A size of the field is predefined (for example, 1 bit).
activation or deactivation field #i
   This field indicates whether to activate or deactivate the indicated time resources (for example, time resources indicated by time resource field #i) and/or the indicated beam indices (for example, beam indices indicated by beam field #i). For example, “0” represents deactivation and “1” represents activation.
   A size of the field is predefined (for example, 1 bit).
   i=0, 1, . . . , I−1. That is, there are I activation or deactivation fields. Optionally, I is indicated by the number field. Optionally, I is predefined (for example, 8).
time resource field #i
   This field is used to indicate time resources. For example, it indicates a time resource included in/associated with the fourteenth time resource configuration information.
   The first time resource indicated by time resource field #0; the second time resource indicated by time resource field #1, and so on.
   Time resource field #i is associated with beam field #i. Beam indices indicated by beam field #0 are applied/used in time resources indicated by time resource field #0; beam indices indicated by beam field #1 are applied/used in time resources indicated by time resource field #1, and so on.
   A size of the field is predefined (for example, one of 2, 3, 4 and 5 bits).
   i=0, 1, . . . , I−1. That is, there are I time resource fields. I is indicated by the number field. Optionally, I is predefined (for example, 8).
beam field #i
   This field is used to indicate beam indices.
   Beam field #0 is used to indicate the first beam (or a beam index used for the NCR-Fwd access link); beam field #1 is used to indicate the second beam (or a beam index for the NCR-Fwd access link), and so on.
   Beam field #i is associated with time resource field #i. Beam indices indicated by beam field #0 are applied/used in time resources indicated by time resource field #0; beam indices indicated by beam field #1 are applied/used in time resources indicated by time resource field #1, and so on.
   A size of the field is predefined (for example, one of 2, 3, 4 and 5 bits).
   i=0, 1, . . . , I−1. That is, there are I beam fields. Optionally, I is indicated by the number field. Optionally, I is predefined (for example, 8).
   If the activation or deactivation field is deactivation (or activation or deactivation field #i is deactivation), there is no beam field #i (or the NCR ignores beam field #i).
time resource periodicity field
   This field is used to indicate a periodicity of (all) time resources indicated by this MAC-CE.
   If all activation or deactivation fields are 0 (for example, deactivation), there is no time resource periodicity field.
time resource SCS field
   This field is used to indicate an SCS of (all) time resources indicated by this MAC-CE.
   If all activation or deactivation fields are 0 (for example, deactivation), there is no time resource SCS field.

When the NCR (e.g., NCR-MT) receives indication information (for example, a MAC-CE for activation) (optionally, and when the NCR transmits a PUCCH with HARQ-ACK information in slot n corresponding to a PDSCH carrying an activation command, from the first slot after slot n+3Nₛₗₒₜ^{subframe,μ} (an SCS of the first slot is determined according to the SCS of time resources indicated by the MAC-CE)), the NCR (e.g., NCR-Fwd) applies/uses (NCR assumption of) beam information on time resources (for example, time resources indicated by time resource field #i). The beam information may be indicated by beam field #i. μ is an SCS configuration of the PUCCH.

When the NCR (e.g., NCR-MT) receives indication information (for example, a MAC-CE for deactivation) (optionally, and when the NCR transmits a PUCCH with HARQ-ACK information in slot n corresponding to a PDSCH carrying an activation command, from the first slot after slot n+3Nₛₗₒₜ^{subframe,μ} (μ is an SCS configuration of the PUCCH) (optionally, an SCS of the first slot is determined according to the SCS of time resources indicated by the MAC-CE)), the NCR (e.g., NCR-Fwd) performs at least one of
stop applying/using (NCR assumption of) the beam information on time resources (for example, time resources indicated by time resource field #i). The beam information may be indicated by beam field #i, or
stop forwarding (for example, uplink forwarding or downlink forwarding) on time resources (for example, time resources indicated by time resource field #i).

The advantage of the MAC-CE design of this example is that the base station can indicate the beam information applicable to time resources in time through the MAC-CE, thereby improving the flexibility of the system.

### Example 2

In Example 2, a MAC-CE activates or deactivates time resources for NCR-Fwd forwarding (for example, downlink transmission or uplink reception). When the MAC-CE activates the time resources, the MAC-CE also indicates beam information (for example, beam indices) used by an NCR-Fwd on the time resources.

An implementation is as follows:

An NCR-MT receives fifth configuration information from a network device. The fifth configuration information includes one or more thirteenth time resource configuration information (for example, one or more thirteenth time resource configuration information is indicated by a list). The thirteenth time resource configuration information is a set of time resources (for example, a list of time resources). The list of time resources is used as an example, which includes one or more fourteenth time resource configuration information.

The thirteenth time resource configuration information may further include SCS configuration information (for example, a reference SCS), and an SCS of the fourteenth time resource configuration information associated with/included in the thirteenth time resource configuration information is determined by the SCS configuration. The thirteenth time resource configuration information may further include periodicity information, and a periodicity of (all) the fourteenth time resource configuration information associated with/included in the thirteenth time resource configuration information is determined by the periodicity information.

The fifth configuration information may further include SCS configuration information (for example, a reference SCS), and the SCS of the fourteenth time resource configuration information associated with/included in the fifth configuration information is determined by the SCS configuration. The fifth configuration information may further include periodicity information, and the periodicity of (all) the fourteenth time resource configuration information associated with/included in the fifth configuration information is determined by the periodicity information.

Parameters included in/associated with the fourteenth time resource configuration information may refer to Example 1.

The NCR-MT further receives MAC-CE signaling from the network device. The description of the MAC-CE field and the description of the NCR behaviors after receiving the MAC-CE may refer to Example 1, which will not be repeated here.

The advantage of the MAC-CE design of this example is that the base station can indicate the beam information applicable to time resources in time through the MAC-CE, thereby improving the flexibility of the system.

### Example 3

In Example 3, a MAC-CE activates or deactivates time resources for NCR-Fwd forwarding (for example, downlink transmission or uplink reception). When the MAC-CE activates the time resources, the MAC-CE also indicates beam information (for example, beam indices) used by an NCR-Fwd on the time resources.

An implementation is as follows:

An NCR-MT receives fifteenth time resource configuration information from a network device. The time resource configuration information is a set of time resources (for example, a list of time resources). The list of time resources is used as an example, which includes M entries. Each entry in the list of time resources includes one or more sixteenth time resource configuration information. The one or more sixteenth time resource configuration information may be indicated by the list of time resources.

An entry (for example, each entry) in the fifteenth time resource configuration information may further include SCS configuration information (for example, a reference SCS), and an SCS of the sixteenth time resource configuration information associated with/included in an entry in the fifteenth time resource configuration information is determined by the SCS configuration. Optionally, an entry (for example, each entry) in the fifteenth time resource configuration information, and a periodicity of (all) the sixteenth time resource configuration information associated with/included in an entry in the fifteenth time resource configuration information are determined by the periodicity information.

The fifteenth time resource configuration information may further include SCS configuration information (for example, a reference SCS), and the SCS of the sixteenth time resource configuration information associated/included by the fifteenth time resource configuration information is determined by the SCS configuration. The fifteenth time resource configuration information and the periodicity of (all) the sixteenth time resource configuration information associated/included with the fifteenth time resource configuration information may be determined by the periodicity information.

The sixteenth time resource configuration information includes/is associated with at least one of the following parameters:
time resource index
slot offset
   This parameter may indicate a location (or offset) of a starting slot of the time resource in a period. The period may be obtained by periodicity information included in second configuration information.
start symbol and length
   This parameter may indicate an index giving valid combinations of start symbol and length (jointly encoded) as a start and length indicator (SLIV). The network device may configure this parameter so that this time resource does not cross a boundary of a slot.
start symbol
   This parameter may indicate an index of a start symbol of a time resource in a starting slot. The starting slot of the time resource may be determined according to the above slot offset.
length
   This parameter may indicate a time length of a time resource. For example, this parameter indicates a number of consecutive symbols/slots corresponding to the time resource.

The NCR-MT further receives MAC-CE signaling from the network device. Information/fields of the MAC-CE signaling (determined by the NCR, or determined by the NCR according to an LCID of the MAC-CE) (hereinafter, “field” is used as an example) include at least one of:
activation or deactivation field
   This field indicates whether to activate or deactivate the indicated time resources (for example, (all) time resources indicated by this MAC-CE, or (all) time resources indicated by a time resource field). For example, “0” represents deactivation; “1” represents activation.
   A size of the field is predefined (for example, 1 bit).
activation or deactivation field #i
   This field indicates whether to activate or deactivate the indicated time resources (for example, the (i+1)-th time resource indicated by the time resource field) and/or the indicated beam indices (for example, beam indices indicated by beam field #i). For example, “0” represents deactivation and “1” represents activation.
   A size of the field is predefined (for example, 1 bit).
   i=0, 1, . . . , I−1. That is, there are I activation or deactivation fields. I may be determined by a number of time resources indicated by a time resource field (or equal to a number of time resources indicated by the time resource field), or I may be predefined (for example, 8).
time resource field
   This field is used to indicate time resources. For example, it indicates an entry in the fifteenth time resource configuration information (e.g., one of M entries). This entry includes/is associated with one or more time resources.
   The (i+1)-th time resource indicated by the time resource field is associated with beam field #i. Beam indices indicated by beam field #0 are applied/used in the first time resource indicated by the time resource field; beam indices indicated by beam field #1 are applied/used in the second time resource indicated by the time resource field, and so on.
   A size of the field is predefined (for example, one of 2, 3, 4 and 5 bits).
beam field #i
   This field is used to indicate beam indices.
   Beam field #0 is used to indicate the first beam (or a beam index used for the NCR-Fwd access link); beam field #1 is used to indicate the second beam (or a beam index for the NCR-Fwd access link), and so on.
   Beam field #i is associated with the (i+1)-th time resource indicated by the time resource field. Beam indices indicated by beam field #0 are applied/used in the first time resource indicated by the time resource field; beam indices indicated by beam field #1 are applied/used in the second time resource indicated by the time resource field, and so on.
   A size of the field is predefined (for example, one of 2, 3, 4 and 5 bits).
   i=0, 1, . . . , I−1. That is, there are I beam fields. Optionally, I may be determined by a number of time resources indicated by a time resource field (or equal to a number of time resources indicated by the time resource field, or I may be predefined (for example, 8).
   If the activation or deactivation field is deactivation (or activation or deactivation field #i is activation and deactivation), there is no beam field #i (or the NCR ignores beam field #i).
time resource periodicity field
   This field is used to indicate a periodicity of (all) time resources indicated by this MAC-CE.
   If all activation or deactivation fields are 0 (for example, deactivation), there is no time resource periodicity field.
time resource SCS field
   This field is used to indicate an SCS of (all) time resources indicated by this MAC-CE.
   If all activation or deactivation fields are 0 (for example, deactivation), there is no time resource SCS field.

When the NCR (e.g., NCR-MT) receives indication information (for example, a MAC-CE for activation) (and when the NCR transmits a PUCCH with HARQ-ACK information in slot n corresponding to a PDSCH carrying an activation command, from the first slot after slot n+3Nₛₗₒₜ^{subframe,μ} (an SCS of the first slot is determined according to the SCS of time resources indicated by the MAC-CE)), the NCR (e.g., NCR-Fwd) may apply/use (NCR assumption of) beam information on time resources (for example, the (i+1)-th time resource indicated by the time resource indication field). The beam information may be indicated by beam field #i. μ is an SCS configuration of the PUCCH.
When the NCR (e.g., NCR-MT) receives indication information (for example, a MAC-CE for deactivation) (and when the NCR transmits a PUCCH with HARQ-ACK information in slot n corresponding to a PDSCH carrying an activation command, from the first slot after slot n+3Nₛₗₒₜ^{subframe,μ} (here, Nₛₗₒₜ^{subframe,μ} is a number of slots per subframe for SCS configuration of the PUCCH transmission)) (μ is an SCS configuration of the PUCCH) (optionally, an SCS of the first slot is determined according to the SCS of time resources indicated by the MAC-CE), the NCR (e.g., NCR-Fwd) may perform at least one of stop applying/using (NCR assumption of) the beam information on time resources (for example, time resources indicated by the time resource field), wherein the beam information may be indicated by beam field #i, or stop forwarding (for example, uplink forwarding or downlink forwarding) on time resources (for example, time resources indicated by the time resource field).

The advantage of the MAC-CE design of this example is that the base station can indicate the beam information applicable to time resources in time through the MAC-CE, thereby improving the flexibility of the system.

### Example 4

In Example 4, a MAC-CE activates or deactivates forwarding resources for NCR-Fwd forwarding (for example, downlink transmission or uplink reception). When the MAC-CE activates the forwarding resources, the MAC-CE can also indicates/updates beam information (for example, beam indices) corresponding to time resources in the forwarding resources.

An implementation is as follows:

An NCR-MT receives sixth configuration information (for example, a semi-persistent access link beam configuration information list) from a network device. The sixth configuration information includes one or more seventh configuration information (for example, one or more seventh configuration information is indicated by a list). The seventh configuration information is, for example, a semi-persistent access link beam configuration. Optionally, a maximum value of the seventh configuration information included in the sixth configuration information is one of 4, 8, 16 and 32.

The seventh configuration information may include one or more forwarding resource configuration information (for example, one or more forwarding resource configuration information is indicated by a list). A forwarding resource configuration information includes beam information (for example, beam index) and seventeenth time resource configuration information.

The seventh configuration information may further include SCS configuration information (for example, a reference SCS), where an SCS of (all) the seventeenth time resource configuration information included in the seventh configuration information is determined by the SCS configuration. The seventh configuration information may further include periodicity information, and a periodicity of (all) the seventeenth time resource configuration information included in the seventh configuration information is determined by the periodicity information.

The sixth configuration information may further include SCS configuration information (for example, a reference SCS), and the SCS of (all) seventeenth time resource configuration information included in/associated with the sixth configuration information is determined by the SCS configuration. The sixth configuration information may further include periodicity information, and the periodicity of (all) the seventeenth time resource configuration information included in/associated with the seventh configuration information is determined by the periodicity information.

The seventeenth time resource configuration information includes/is associated with at least one of the following parameters:
time resource index
slot offset
   This parameter may indicate a location (or offset) of a starting slot of the time resource in a period. The period may be obtained by the periodicity information included in the seventh configuration information.
start symbol and length
   This parameter may indicate an index giving valid combinations of start symbol and length (jointly encoded) as a start and length indicator (SLIV). The network device may configure this parameter so that this time resource does not cross a boundary of a slot.
start symbol
   This parameter may indicate an index of a start symbol of a time resource in a starting slot. The starting slot of the time resource may be determined according to the above slot offset.
length
   This parameter may indicate a time length of a time resource. For example, this parameter indicates a number of consecutive symbols/slots corresponding to the time resource.

In an implementation, the NCR-MT further receives MAC-CE signaling from the network device. Information/fields of the MAC-CE signaling (determined by the NCR, or determined by the NCR according to an LCID of the MAC-CE) (hereinafter, field) include at least one of.
activation or deactivation field
   This field is used to indicate whether to activate or deactivate. (For example, activate or deactivate the seventh configuration information, and For example, activate or deactivate the forwarding resources indicated by the MAC-CE). For example, “0” represents deactivation and “1” represents activation.
activation or deactivation field #i.
   This field indicates whether to activate or deactivate the indicated forwarding resources (for example, forwarding resources indicated by forwarding resource indication field #j) and/or the indicated beam indices (for example, beam indices indicated by beam field #j). For example, “0” represents deactivation and “1” represents activation.
   A size of the field is predefined (for example, 1 bit).
   i=0, 1, . . . , I−1. That is, there are I activation or deactivation fields. I may be determined by a number in the number field (or equal to a number indicated by the number field), or I may be predefined (for example, 8).
number field
   This field is used to indicate a number of the forwarding resources indicated in this MAC-CE (or forwarding resources for an NCR-Fwd access link).
forwarding resource indication field #j
   This field is used to indicate forwarding resources. For example, it indicates a forwarding resource included in/associated with the seventh configuration information.
   Forwarding resource indication field #0 indicates the first forwarding resource; forwarding resource indication field #1 indicates the second forwarding resource, and so on.
   j=0, 1, . . . , J−1. J is determined according to an indication of the number field.
existence indicator
   This field is used to indicate whether a beam field exists (or whether the beam field exists in MAC-CE activation signaling). For example, when a value of the field is 0, the beam field (or all beam fields) does not exist. In this case, the time resources in the forwarding resources indicated by the MAC-CE correspond to the beam information in the forwarding resources (that is, the beam information will be applied to the corresponding time resources). For example, when the value of the field is 1, the beam field (or all beam fields) exists. In this case, the time resources in the forwarding resources indicated by the MAC-CE correspond to the beam information indicated by the beam field (that is, the beam information indicated by the MAC-CE beam indication field will be applied to the corresponding time resources; while the beam information originally configured in the forwarding resources will be overridden).
beam field #j
   The beam fields correspond to the forwarding resources one by one. For example, beam field #0 corresponds to forwarding resource indication field #0 (indicating that time resources in forwarding resources indicated by forwarding resource indication field #0 apply beam indices indicated by beam field #0); beam field #1 corresponds to forwarding resource indication field #0 (indicating that time resources in forwarding resources indicated by forwarding resource indication field #1 apply beam indices indicated by beam field #0), and so on.
   j=0, 1, . . . , J−1. J is determined according to the indication of the number field.
   When the beam indication field is indicated to be activated, the beam indication field exists; otherwise, when the beam indication field is indicated to be deactivated, the beam field does not exist.
   When the beam indication field is indicated to be activated and the existence indicator indicates existence, the beam indication field exists; otherwise, the indication field does not exist.

In another implementation, the NCR-MT further receives MAC-CE signaling from the network device. Information/fields of the MAC-CE signaling (determined by the NCR, or determined by the NCR according to an LCID of the MAC-CE) (hereinafter, “field” is used as an example) include at least one of
activation or deactivation field
   This field is used to indicate whether to activate or deactivate. (For example, activate or deactivate the seventh configuration information, and For example, activate or deactivate the forwarding resource configuration information). For example, “0” represents deactivation and “1” represents activation.
activation or deactivation field #i
   This field indicates whether to activate or deactivate the indicated forwarding resources (for example, the (j+1)-th forwarding resource indicated by the forwarding resource indication field) and/or the indicated beam indices (for example, beam indices indicated by beam field #j). For example, “0” represents deactivation and “1” represents activation.
   A size of the field is predefined (for example, 1 bit).
   i=0, 1, . . . , I−1. That is, there are I activation or deactivation fields. Optionally, I is determined by a number of forwarding resources indicated by the forwarding resource indication field. Optionally, I is predefined (for example, 8).
forwarding resource indication field
   This field is used to indicate forwarding resources. For example, an entry in the sixth configuration information (for example, a seventh configuration information) is indicated. This entry includes/is associated with one or more forwarding resources.
   The (i+1)-th forwarding resource indicated by the forwarding resource indication field is associated with beam field #i. Beam indices indicated by beam field #0 are applied/used in time resources associated with the first forwarding resource indicated by the forwarding resource field; beam indices indicated by beam field #1 are applied/used in time resources associated with the second forwarding resource indicated by the forwarding resource field, and so on.
   A size of the field is predefined (for example, one of 2, 3, 4 and 5 bits).
existence indicator
   This field is used to indicate whether a beam field exists (or whether the beam field exists in MAC-CE activation signaling). For example, when a value of the field is 0, the beam field (or all beam fields) does not exist. In this case, the time resources in the forwarding resources indicated by the MAC-CE correspond to the beam information in the forwarding resources (that is, the beam information will be applied to the corresponding time resources). For example, when the value of the field is 1, the beam field (or all beam fields) exists. In this case, the time resources in the forwarding resources indicated by the MAC-CE correspond to the beam information indicated by the beam field (that is, the beam information indicated by the MAC-CE beam indication field will be applied to the corresponding time resources; while the beam information configured in the forwarding resources will be overridden).
beam field #j
   j=0, 1, . . . , J−1. J is determined according to the number of forwarding resources indicated by the forwarding resource indication field.
   The beam fields correspond to the forwarding resources one by one. For example, beam field #0 corresponds to the first forwarding resource in the seventh configuration information indicated by the forwarding resource indication field (beam indices indicated by beam field #0 are applied to this forwarding resource); beam field #1 corresponds to the second forwarding resource in the seventh configuration information indicated by the forwarding resource indication field (beam indices indicated by beam field #0 are applied to this forwarding resource), and so on.
   When the beam indication field is indicated to be activated, the beam indication field exists; otherwise, when the beam indication field is indicated to be deactivated, the beam field does not exist.
   When the beam indication field is indicated to be activated and the existence indicator indicates existence, the beam indication field exists; otherwise, the indication field does not exist.

The advantage of this MAC-CE field design is that the base station can indicate/update the beam information applicable to the forwarding resources in time through the MAC-CE, thereby improving the flexibility of the system.

When the NCR (e.g., NCR-MT) receives indication information (for example, a MAC-CE for activation) (optionally, and when the NCR-MT transmits a PUCCH with HARQ-ACK information in slot n associated with a PDSCH carrying an activation command, from the first slot after slot n+3Nₛₗₒₜ^{subframe,μ} (optionally, an SCS of the first slot is determined according to the SCS of time resources indicated by the MAC-CE)), the NCR (e.g., NCR-Fwd) applies/uses (NCR assumption of) beam information on time resources (for example, time resources corresponding to/associated with the indicated forwarding resources). The beam information corresponds to/is associated with the indicated forwarding resource configuration information. The beam information is indicated by the MAC-CE. μ is an SCS configuration of the PUCCH.

When the NCR (e.g., NCR-MT) receives indication information (for example, a MAC-CE for deactivation) (optionally, and when the NCR-MT transmits a PUCCH with HARQ-ACK information in slot n associated with a PDSCH carrying an deactivation command, from the first slot after slot n+3Nₛₗₒₜ^{subframe,μ} (μ is an SCS configuration of the PUCCH) (optionally, an SCS of the first slot is determined slot according to the SCS of time resources indicated by the MAC-CE)), the NCR (e.g., NCR-Fwd) performs at least one of:
stop applying/using (NCR assumption of) the beam information on time resources (for example, time resources indicated by the time resource field). The beam information corresponds to/is associated with the indicated forwarding resource configuration information. The beam information is indicated by the MAC-CE, or
stop forwarding (for example, uplink forwarding or downlink forwarding) on time resources (for example, time resources indicated by the time resource field).

The advantage of the MAC-CE design of this example is that the base station can indicate/update the beam information applicable to the forwarding resources in time through the MAC-CE, thereby improving the flexibility of the system.

Embodiment 2 provides a method for beam indicating using the MAC-CE signaling, which is helpful for the NCR to forward semi-persistent signals from the base station in a specific direction, thereby improving the indicating efficiency and improving the performance of the communication system. Moreover, the MAC-CE can also be used to indicate the turning on and off of the NCR, so as to avoid turning on the NCR at unnecessary time resources and save energy.

### Embodiment 3

FIG. 5C illustrates a method 530 performed by a repeater according to an embodiment. In step 531, an NCR receives configuration information and/or MAC-CE signaling from a network device. In step 532, the NCR applies corresponding beam information for DL transmission and/or UL reception on time resources indicated by the configuration information and/or MAC-CE signaling.

### Example 1

In Example 1, an NCR-MT receives first configuration information (for example, a periodic access link beam configuration information list) from a network device. The first configuration information includes one or more second configuration information (for example, one or more second configuration information is indicated by a list). The second configuration information is, for example, a periodic access link beam configuration. Optionally, a maximum value of the second configuration information included in the first configuration information is one of 4, 8, 16 and 32.

The second configuration information may include one or more forwarding resource configuration information (for example, one or more forwarding resource configuration information is indicated by a list). A forwarding resource configuration information includes beam information (for example, beam indices) and tenth time resource configuration information. The second configuration information may further include SCS configuration information (for example, a reference SCS), and an SCS of (all) the tenth time resource configuration information included in the second configuration information is determined by the SCS configuration. The second configuration information may further include periodicity information, and a periodicity of (all) the tenth time resource configuration information included in the second configuration information is determined by the periodicity information.

The tenth time resource configuration information includes/is associated with at least one of the following parameters:
time resource index
   slot offset
      This parameter may indicate a location (or offset) of a starting slot of the time resource in a period. The period may be obtained by the periodicity information included in the second configuration information.
   start symbol and length
      This parameter may indicate an index giving valid combinations of start symbol and length (jointly encoded) as a start and length indicator (SLIV). The network device may configure this parameter so that this time resource does not cross a boundary of a slot.
   start symbol
      This parameter may indicate an index of a start symbol of a time resource in a starting slot. The starting slot of the time resource may be determined according to the above slot offset.
   length
      This parameter may indicate a time length of a time resource. For example, this parameter indicates a number of consecutive symbols/slots corresponding to the time resource.

The NCR applies beams (or beam indices) indicated by the first configuration information to/for downlink transmission and/or uplink reception (or access link forwarding) in time resources indicated by the first configuration information. For example, an NCR-Fwd performs forwarding according to the forwarding resource configuration information indicated by the second configuration information in the first configuration information. The NCR-Fwd uses beam indices (related spatial filter) of configuration forwarding information to forward on time resources corresponding to/indicated by the tenth time resource configuration information in the forwarding configuration information. The NCR may apply all the forwarding configuration information in the first configuration information (or all the forwarding configuration information in all the second configuration information in the first configuration information).

### Example 2

In Example 2, an NCR-MT receives eleventh time resource configuration information from a network device. The time resource configuration information is a set of time resources (for example, a list of time resources). The list of time resources is used as an example, which includes K entries. Each entry includes a twelfth time resource configuration information. That is, the time list includes K twelfth time resource configuration information. A twelfth time resource configuration information includes/is associated with at least one of the following parameters:
time resource index
slot offset
   This parameter may indicate a location (or offset) of a starting slot of the time resource in a period.
start symbol and length
   This parameter may indicate an index giving valid combinations of start symbol and length (jointly encoded) as a start and length indicator (SLIV). The network device may configure this parameter so that this time resource does not cross a boundary of a slot.
start symbol
   This parameter may indicate an index of a start symbol of a time resource in a starting slot. The starting slot of the time resource may be determined according to the above slot offset.
length
   This parameter may indicate a time length of a time resource. For example, this parameter indicates a number of consecutive symbols/slots corresponding to the time resource.

The NCR-MT further receives third configuration information (for example, a periodic access link beam configuration information list) from the network device. The third configuration information includes one or more fourth configuration information (for example, one or more fourth configuration information is indicated by a list). The fourth configuration information is, for example, a periodic access link beam configuration. A maximum value of the fourth configuration information included in the third configuration information may be one of 4, 8, 16 and 32.

The fourth configuration information may include one or more forwarding resource configuration information (for example, one or more forwarding resource configuration information is indicated by a list). A forwarding resource configuration information includes beam information (for example, beam indices) and one or more time resource indices (for example, the indices are used to refer to the twelfth time resource configuration information in the eleventh time resource configuration information). The fourth configuration information may further include SCS configuration information (for example, a reference SCS), and an SCS of (all) the associated twelfth time resource configuration information in the fourth configuration information is determined by the SCS configuration. The second configuration information may further include periodicity information, and a periodicity of (all) the associated twelfth time resource configuration information in the second configuration information is determined by the periodicity information.

The NCR uses beams (or beam indices) indicated by the third configuration information for downlink transmission and/or uplink reception (or access link forwarding) in time resources indicated by the third configuration information. For example, an NCR-Fwd performs forwarding according to the forwarding resource configuration information indicated by the fourth configuration information in the third configuration information. The NCR-Fwd uses beam indices (related spatial filter) of configuration forwarding information to forward on time resources corresponding to/indicated by the twelfth time resource configuration information in the forwarding configuration information. The NCR may apply all the forwarding configuration information in the third configuration information (or all the forwarding configuration information in all the fourth configuration information in the third configuration information).

The third embodiment provides a method for periodic beam indicating, which is helpful for the NCR to forward periodic signals from the base station in a specific direction, thereby improving the indicating efficiency and improving the performance of the communication system.

### Embodiment 4

FIG. 5D illustrates a method 540 performed by a repeater according to an embodiment. In step 541, an NCR receives MAC-CE signaling from a network device. The MAC-CE refers to at least one of:
a MAC-CE of an access link beam indication;
a MAC-CE for notifying a beam indication of an NCR-Fwd access link; or
a MAC-CE for carrying side control information,

In step 542, the NCR applies/uses a transmission configuration indication (TCI) state and/or a sounding reference signal (SRS) resource indication (SRI) indicated by the MAC-CE signaling for DL reception and/or UL transmission. The NCR may apply/use a spatial filter associated with the TCI state and/or SRI indicated by the MAC-CE signaling for downlink reception and/or uplink transmission.

The NCR-MT can be configured with a list of configurations including at most M TCI states (e.g., tci-StatesToAddModList and/or tci-StatesToReleaseList) in a UE-specific PDSCH higher layer parameter (for example, PDSCH-config). The PDSCH higher layer parameter is used to decode a PDSCH according to the detected (for (corresponding serving cells of) the NCR-MT) PDCCH. M is based on a UE/NCR capability parameter (for example, a maximum number of configured TCI states per CC (maxNumberConfiguredTCIstatesPerCC)). Each TCI state configuration parameter (for example, TCI-State) includes a parameter configuring a quasi co-location relationship between one or two downlink reference signals and at least one of the following ports:
PDSCH demodulation reference signal (DM-RS) port;
PDCCH demodulation reference signal (DM-RS) port; or
CSI-RS port of a CSI-RS resource.

The NCR-MT can be configured with a configuration of at most 128 TCI states in a DL or joint TCI state list parameter (for example, dl-OrJoint-TC/StateList) in a UE-specific PDSCH parameter (for example, PDSCH-config). The TCI state (configuration) or each TCI state (configuration) may provide a demodulation reference signal of the PDCCH, a demodulation reference signal of the PDSCH and a quasi co-location reference signal of the CSI-RS of the NCR-MT, and/or (if applicable) provides a reference for determining a UL transmission spatial filter of dynamic grant and configuration grant-based PUSCH, PUCCH resources and SRS of the NCR-MT.

The NCR-MT can be configured with a configuration of at most 64 uplink TCI states in a dedicated UE-specific uplink BWP parameter (for example, BWP-UplinkDedicated). The UL TCI state (configuration) or each uplink TCI state (configuration) includes a parameter for configuring a reference signal (if applicable) for determining the UL transmission spatial filter of the dynamic grant and configuration grant-based PUSCH, PUCCH resources and SRS of the NCR-MT.

### Example 1

In this example, an NCR-MT receives TCI state configuration information from a network device. The TCI state configuration information may refer to a first TCI state parameter (for example, tci-StatesToAddModList and/or tci-StatesToReleaseList) that configures a TCI list. Alternatively, the TCI state configuration information may refer to a second TCI state parameter (for example, dl-OrJoint-TCIStateList or dl-OrJoint-TCI-State-ToAddModList) that configures a TCI state (for example, unified TCI state; for another example, downlink or joint TCI state) list.

The tci-StatesToAddModList and/or tci-StatesToReleaseList is in PDSCH-Config. The PDSCH-Config is in a BWP of a cell/serving cell. The cell/serving cell is a PCell of the NCR-MT. The cell is indicated by the MAC-CE signaling, or an ID of the cell is indicated by the MAC-CE signaling. The cell receives the MAC-CE signaling. The BWP is, for example, an active BWP. The BWP is indicated by the MAC-CE signaling, or an ID of the BWP is indicated by the MAC-CE signaling; the cell receives the MAC-CE signaling.

The dl-OrJoint-TCI-State-ToAddModList or dl-OrJoint-TCIStateList is in PDSCH-Config. The PDSCH-Config is in a BWP of a cell/serving cell. The cell/serving cell is a PCell of the NCR-MT. The cell is indicated by the MAC-CE signaling, or an ID of the cell is indicated by the MAC-CE signaling. The cell receives the MAC-CE signaling. The BWP is an active BWP. The BWP is indicated by the MAC-CE signaling, or an ID of the BWP is indicated by the MAC-CE signaling. The cell receives the MAC-CE signaling.

The NCR-MT receives SRS configuration information (or SRS resource configuration information) from the network device.

The NCR-MT further receives MAC-CE signaling from the network device. Information/fields of the MAC-CE signaling (determined by the NCR, or determined by the NCR according to an LCID of the MAC-CE) (hereinafter, field) include at least one of
serving cell ID field
   A size of the field may be 5 bits.
BWP ID field
   A size of the field may be 2 bits.
TCI state ID field (or TCI state field)
   When the NCR-MT is configured with the second TCI state parameter (for example, a DL or joint TCI state list dl-OrJoint-TCIStateList), a TCI state indicated by this field is used for uplink transmission and downlink reception of the NCR-Fwd. That is, the NCR-Fwd uses/applies/determines a spatial filter associated with the TCI state (or a spatial filter same as a spatial filter that receives a DL signal associated with the TCI state) for uplink transmission and downlink reception of the NCR-Fwd (backhaul link).
   When the NCR-MT is not configured with the second TCI state parameter (for example, the DL or joint TCI state list dl-OrJoint-TCIStateList), the TCI state indicated in this field is used for downlink reception of the NCR-Fwd. That is, the NCR-Fwd uses/applies/determines the spatial filter associated with the TCI state (or the spatial filter same as the spatial filter that receives the DL signal associated with the TCI state) for downlink reception of the NCR-Fwd (backhaul link).
   The TCI state ID may be from a TCI configuration parameter of an active BWP in a serving cell indicated by the serving cell ID field. The TCI configuration parameter is, for example, a first parameter. The TCI configuration parameter is, for example, a second parameter.
   The TCI state ID may be from a TCI configuration parameter of a BWP indicated by the BWP ID field in the serving cell indicated by the serving cell ID field. The TCI configuration parameter is, for example, a first parameter. The TCI configuration parameter is, for example, a second parameter.
   a size of the field may be 7 bits.
SRI field (or SRS resource indication field)
   An SRI indicated by this field is used for uplink transmission of the NCR-Fwd. That is, the NCR-Fwd uses/applies/determines a spatial filter associated with the SRI for downlink reception of the NCR-Fwd (backhaul link).
   When the NCR-MT is not configured with the second TCI state parameter (for example, dl-OrJoint-TCIStateList), the SRI indicated by this field may be used for uplink transmission of the NCR-Fwd. That is, the NCR-Fwd uses/applies/determines a spatial filter associated with the SRI for downlink reception of the NCR-Fwd (backhaul link).
   When the NCR-MT is configured with the second TCI state parameter (for example, dl-OrJoint-TCIStateList), this field may not be present.
   When the NCR-MT is configured with the second parameter (for example, dl-OrJoint-TCIStateList), the NCR may ignore this field.
   a size of the field may be 4 bits.

When the NCR (e.g., NCR-MT) receives the MAC-CE (for example, a MAC-CE activation command for activation) (optionally, and when the NCR transmits a PUCCH with HARQ-ACK information in slot n corresponding to a PDSCH carrying the MAC-CE, from the first slot after slot n+3Nₛₗₒₜ^{subframe,μ} (optionally, an SCS of the first slot is determined according to a reference SCS)), the NCR (e.g., NCR-Fwd) applies/uses the TCI state and/or SRI indicated by the MAC-CE. μ is an SCS configuration of the PUCCH.

The MAC-CE described in this method can indicate the UL beam (SRI) and downlink beam (TCI) of the backhaul link at the same time, thereby improving the indicating efficiency and increasing the flexibility of the communication system.

### Example 2

In this example, an NCR-MT receives TCI state configuration information from a network device. The TCI state configuration information may refer to a first TCI state parameter (for example, tci-StatesToAddModList and/or tci-StatesToReleaseList) that configures a TCI list. Alternatively, the TCI state configuration information may refer to a second TCI state parameter (for example, dl-OrJoint-TCIStateList or dl-OrJoint-TCI-State-ToAddModList) that configures a TCI state (for example, unified TCI state; for another example, downlink or joint TCI state) list.

The tci-StatesToAddModList and/or tci-StatesToReleaseList is in PDSCH-Config. The PDSCH-Config is in a BWP of a cell/serving cell. The cell/serving cell is, for example, a PCell of the NCR-MT. The cell is indicated by the MAC-CE signaling, or an ID of the cell is indicated by the MAC-CE signaling; the cell is, For example, a cell that receives the MAC-CE signaling. The BWP is an active BWP indicated by the MAC-CE signaling, or an ID of the BWP is indicated by the MAC-CE signaling. The cell receives the MAC-CE signaling.

The dl-OrJoint-TCI-State-ToAddModList or dl-OrJoint-TCIStateList is in PDSCH-Config. The PDSCH-Config is in a BWP of a cell/serving cell. The cell/serving cell is a PCell of the NCR-MT. The cell is indicated by the MAC-CE signaling, or an ID of the cell is indicated by the MAC-CE signaling. The cell receives the MAC-CE signaling. The BWP is an active BWP indicated by the MAC-CE signaling, or an ID of the BWP is indicated by the MAC-CE signaling. The cell receives the MAC-CE signaling.

The NCR-MT may receive SRS configuration information (or SRS resource configuration information) from the network device.

The NCR-MT further receives MAC-CE signaling from the network device. Information/fields of the MAC-CE signaling (determined by the NCR, or determined by the NCR according to an LCID of the MAC-CE) include at least one of:
serving cell ID field
   A size of the field may be 5 bits.
BWP ID field
   A size of the field may be 2 bits.
resource type field (or UL and DL field, or beam type field)
   This field is used to indicate whether a resource ID corresponds to a TCI state (DL) or an SRI (UL). For example, when this field indicates 0, a resource ID field is used to indicate the TCI state. For example, when this field indicates 1, the resource ID field is used to indicate the SRI.
   A size of the field is predefined (for example, 1 bit).
   When the NCR-MT is configured with the second TCI state parameter (for example, dl-OrJoint-TCIStateList), the size of the field may be 1 bit. The field is set to a specific value (for example, 0).
   When the NCR-MT is configured with the second TCI state parameter (for example, dl-OrJoint-TCIStateList), this field may not be present.
   When the NCR-MT is configured with the second TCI state parameter (for example, dl-OrJoint-TCIStateList), the NCR may ignore this field.
resource ID field
   This field indicates a value of the TCI state ID or SRI.
   When the NCR-MT is not configured with the second TCI state parameter (for example, dl-OrJoint-TCIStateList), this field, in combination with the resource type field, determines whether the TCI state or the SRI is indicated.
   When the TCI state is indicated, the TCI state is used for DL reception of the NCR-Fwd. That is, the NCR-Fwd uses/applies/determines the spatial filter associated with the TCI state (or the spatial filter same as the spatial filter that receives the DL signal associated with the TCI state) for DL reception of the NCR-Fwd (backhaul link).
   When the SRI is indicated, the SRI is used for UL transmission of the NCR-Fwd. That is, the NCR-Fwd uses/applies/determines a spatial filter associated with the SRI for UL transmission of the NCR-Fwd (backhaul link).
   When the NCR-MT is configured with the second TCI state parameter (for example, dl-OrJoint-TCIStateList), this field indicates the TCI state. This TCI state is used for UL transmission and DL reception of the NCR-Fwd. That is, the NCR-Fwd uses/applies/determines a spatial filter associated with the TCI state (or a spatial filter same as a spatial filter that receives a DL signal associated with the TCI state) for UL transmission and DL reception of the NCR-Fwd (backhaul link).
   The TCI state ID may be from a TCI configuration parameter of an active BWP in a serving cell indicated by the serving cell ID field. The TCI configuration parameter is a first parameter. The TCI configuration parameter is a second parameter.
   The TCI state ID may be from a TCI configuration parameter of a BWP indicated by the BWP ID field in the serving cell indicated by the serving cell ID field (for example). The TCI configuration parameter is a first parameter. The TCI configuration parameter is a second parameter.
   The SRI may be from an SRS configuration parameter of the active BWP in the serving cell indicated by the serving cell ID field.
   The SRI may be from an SRS configuration parameter of the BWP indicated by the BWP ID field in the serving cell indicated by the serving cell ID field.
   Optionally, a size of the field is predefined (for example, 7 bits). When this field indicates the TCI state, these 7 bits are used to indicate the TCI state. When this field indicates the SRI, four rightmost bits of this field are used to indicate the SRI.

When the NCR (e.g., NCR-MT) receives the MAC-CE (for example, a MAC-CE activation command for activation) (optionally, and when the NCR transmits a PUCCH with HARQ-ACK information in slot n corresponding to a PDSCH carrying the MAC-CE, from the first slot after slot n+3Nₛₗₒₜ^{subframe,μ} (an SCS of the first slot is determined according to a reference SCS)), the NCR (e.g., NCR-Fwd) may apply/use the TCI state and/or SRI indicated by the MAC-CE. μ is an SCS configuration of the PUCCH.

The MAC-CE described in this method can use the same format to indicate the UL beam (SRI) and DL beam (TCI) of the backhaul link respectively, thereby reducing the overhead and improving the efficiency of the communication system.

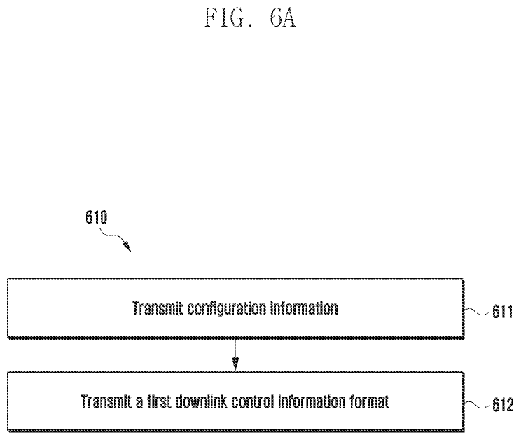

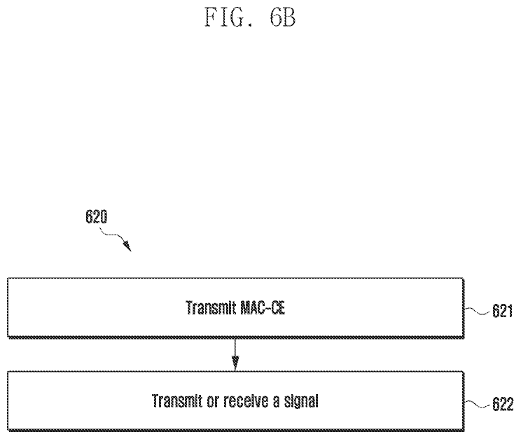

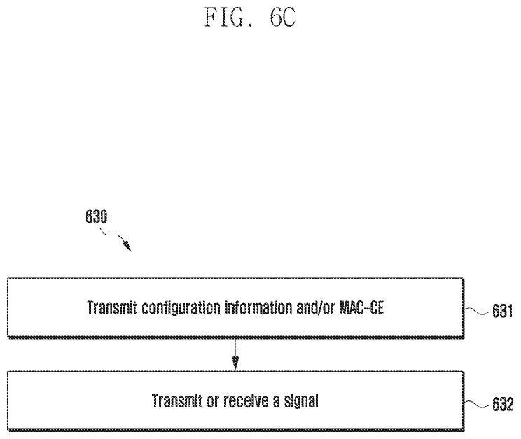

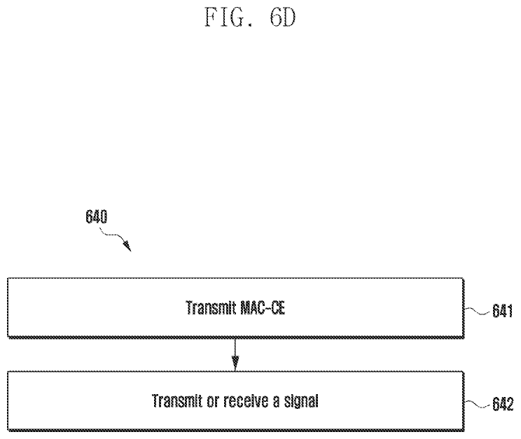

FIG. 6A illustrates a method 610 performed by a network device according to an embodiment. FIG. 6B illustrates a method 620 performed by a network device according to an embodiment. FIG. 6C illustrates a method 630 performed by a network device according to an embodiment. FIG. 6D illustrates a method 640 performed by a network device according to an embodiment.

Specifically, FIGS. 6A-6D illustrate flowcharts of methods 610-640 performed by a network device corresponding to methods 510-540 performed by a repeater as shown in FIGS. 5A-5D according to an embodiment.

In FIG. 6A, in step 611, configuration information is transmitted to a repeater. In step 612, a first DCI format is transmitted to the repeater, wherein the configuration information is used to indicate whether the repeater monitors and/or detects the first DCI format, and wherein the first DCI format is used to inform a beam indication of an access link for the repeater.

In FIG. 6B, in step 621, a MAC-CE is transmitted to a repeater. In step 622, a signal is transmitted or received, wherein the MAC-CE is used to inform a beam indication of an access link for the repeater.

In FIG. 6C, in step 631, configuration information and/or a MAC-CE is transmitted to a repeater. In step 632, a signal is transmitted or received, wherein the repeater applies corresponding beam information for DL transmission and/or UL reception on a time resource indicated by the configuration information and/or the MAC-CE signaling.

In FIG. 6D, in step 641, a MAC-CE is transmitted to a repeater. In step 642, a signal is transmitted or received, wherein the MAC-CE is used to inform a beam indication of a backhaul link of the repeater.

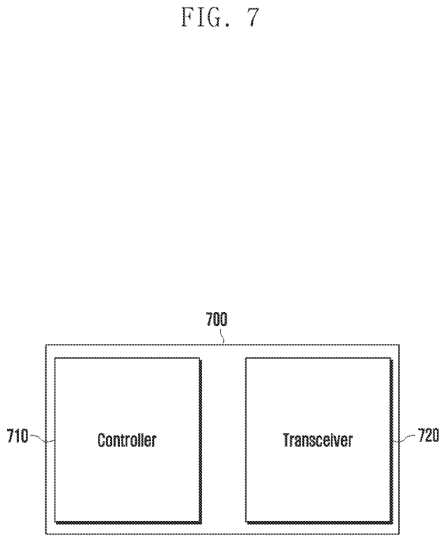

FIG. 7 illustrates a structure 700 of a repeater according to an embodiment. As shown in FIG. 7, the repeater 700 includes a controller 710 and a transceiver 720, wherein the controller 710 is configured to perform the above methods disclosed herein that are performed by the repeater, and the transceiver 720 is configured to transceive channels or signals.

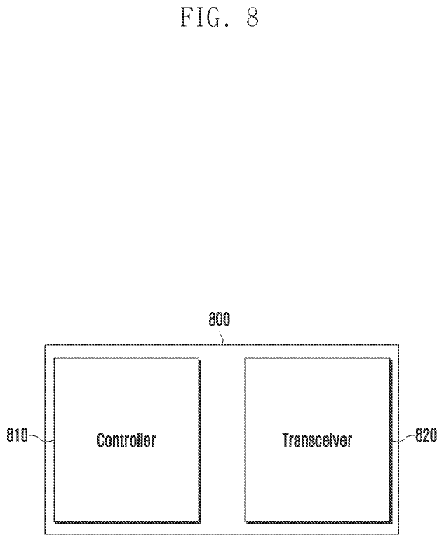

FIG. 8 illustrates a structure 800 of a network device according to an embodiment. As shown in FIG. 8, the network device 800 includes a controller 810 and a transceiver 820, wherein the controller 810 is configured to perform the above methods disclosed herein that are performed by the network device, and the transceiver 820 is configured to transceive channels or signals.

The illustrative logical blocks, modules, and circuits described in the disclosure may be implemented in a general-purpose processor, a digital signal processor (DSP), an application specific integrated circuit, ASIC), field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in this disclosure may be embodied directly in hardware, in a software module executed by a processor, or in a combination of the two. Software modules may reside in random access memory (RAM), flash memory, read only memory (ROM), erasable programmable ROM (EPROM) memory, electronically erasable PROM (EEPROM), registers, hard disks, removable disks, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

The described functions herein may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods and devices, and does not represent all examples that can be realized or are within the scope of the claims. As used herein, the term example indicates serving as an example, instance or illustration rather than preferred or superior to other examples. The detailed description includes specific details to provide an understanding of the described technology. However, these techniques may be practiced without these specific details. In some cases, well-known structures and devices are shown in block diagram form to avoid obscuring the concepts of the described examples.

The specific order or hierarchy of steps in the method of the present disclosure is illustrative of an exemplary process. Based on the design preference, it can be understood that the specific order or hierarchy of steps in the method can be rearranged to realize the functions and effects disclosed in the disclosure. Although elements may be described or claimed in the singular, the plural is also contemplated unless the limitation on the singular is explicitly stated. Therefore, the disclosure is not limited to the illustrated examples, and any means for performing the functions described herein are included in various aspects of the disclosure.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a network-controlled repeater (NCR) in a wireless communication system, the method comprising:
obtaining NCR configuration information from a network node; and
monitoring or detecting a first downlink control information format according to the NCR configuration information,
wherein the first downlink control information format is used to inform a beam indication of an access link for the NCR.

2. The method of claim 1, further comprising:
applying the beam indication for at least one of downlink reception or uplink forwarding after the first downlink control information format is detected.

3. The method of claim 1,
wherein the first downlink control information format includes at least one first field that indicates beams, and
wherein a bit width of each first field is greater than or equal to max{┌log₂ N_{beam}┐,1}, where N_{beam} is a number of access link beam candidates of the NCR.

4. The method of claim 3,
wherein the NCR configuration information includes information that indicates a maximum number of beams indicated by the first downlink control information format, and
wherein a number of the first fields is equal to the maximum number of beams.

5. The method of claim 3,
wherein the first downlink control information format further includes at least one second field that indicates time resources,
wherein a number of the second fields is equal to the maximum number of beams, and
wherein the second fields correspond to the first fields one by one.

6. The method of claim 5, wherein the at least one second field and the at least one first field satisfy at least one of the following relationships:
in case that a first symbol is in time resources indicated by multiple second fields, or values of the multiple second fields are identical, or the time resources indicated by the multiple second fields are not time-division multiplexed, values of first fields corresponding to the multiple second fields are identical;
in case that values of multiple first fields are different, time resources indicated by second fields corresponding to the multiple first fields are not time-division multiplexed; and
in case that the values indicated by the multiple first fields are identical, values of the second fields corresponding to the multiple first fields are identical.

7. The method of claim 1, wherein in case that at least one first downlink control information format is detected, the at least one downlink control information format indicates multiple time resources, and a first symbol is in the multiple time resources, the multiple time resources satisfy at least one of the following relationships:
values of beam indices corresponding to the multiple time resources are identical; and
a beam index corresponding to the first symbol is determined according to a last first downlink control information format of the at least one first downlink control information format.

8. The method of claim 1, further comprising:
obtaining first configuration information that indicates time resources from the network node, the first configuration information including one or more entries, and each entry is associated with one or more time resources; and
in case that the entry of the first configuration information is configured with configuration information on subcarrier spacing, determining a subcarrier spacing corresponding to a time resource associated with the entry of the first configuration information according to the configuration information on subcarrier spacing; or
in case that the entry of the first configuration information is not configured with the configuration information on subcarrier spacing, determining the subcarrier spacing of the time resource associated with the entry of the first configuration information according to a subcarrier spacing of the NCR.

9. The method of claim 8,
wherein the first downlink control information format includes one second field, and a value of the second field is associated with one entry in the first configuration information; or
wherein the first downlink control information format includes at least one second field, and a value of each second field is used to indicate one time resource.

10. The method of claim 1, wherein,
in case that the first downlink control information format and a second downlink control information format are detected, hybrid automatic repeat request acknowledgement (HARQ-ACK) information corresponding to the first downlink control information format and the second downlink control information format corresponds to different slots respectively; or
in case that the first downlink control information format and the second downlink control information format are detected, and the HARQ-ACK information corresponding to the first downlink control information format and the second downlink control information format corresponds to a same slot, at least one of the following operations is performed:
discarding the HARQ-ACK information corresponding to the first downlink control information format or discarding the HARQ-ACK information corresponding to the second downlink control information format; and
generating only the HARQ-ACK information corresponding to the first downlink control information format or to the second downlink control information format.

11. A method performed by a network-controlled repeater (NCR) in a wireless communication system, the method comprising:
receiving a media access control-control element (MAC-CE) from a network node; and
starting or stopping application of beam information indicated by the MAC-CE on a time resource indicated by the MAC-CE,
wherein the beam information is used for at least one of downlink forwarding or uplink reception of the NCR, and
wherein the MAC-CE is used to notify a beam indication of an access link for the NCR.

12. The method of claim 11,
wherein the MAC-CE includes at least one fifth field for activating or deactivating the beam indication, and
wherein the at least one fifth field is used to indicate whether to start or stop the application of the beam information on the time resource indicated by the MAC-CE.

13. The method of claim 12, wherein:
in case that first fields that indicates beams correspond to the fifth fields one by one and any of the fifth fields indicates deactivation, a first field corresponding to the any of the fifth fields is not present in the MAC-CE; or
in case that a number of the fifth fields included in the MAC-CE is 1 and the fifth fields indicate deactivation, the first field is not present in the MAC-CE.

14. The method of claim 11,
wherein the MAC-CE includes at least one first field that indicates beams and at least one second field that indicates time resources, and
wherein the first fields correspond to the second fields one by one.

15. The method of claim 11,
wherein the MAC-CE includes at least one first field that indicates beams and at least one eighth field that indicates forwarding resources, and
wherein the first fields correspond to the eighth fields one by one.

16. The method of claim 12, wherein,
a number of the first fields is determined according to at least one of a number of time resources indicated by the second fields, a sixth field that indicates a number of the first fields and/or the second fields, a number of forwarding resources indicated by the eighth fields, and a ninth field that indicates a number of the first fields and/or the eighth fields; and
a number of the fifth fields is determined according to at least one of the number of the time resources indicated by the second fields, and a seventh field that indicates the number of the fifth fields.

17. A method performed by a network-controlled repeater (NCR) in a wireless communication system, the method comprising:
receiving a media access control-control element (MAC-CE) from a network node; and
applying a transmission control indication (TCI) state or a sounding reference signal resource indication (SRI) indicated by the MAC-CE for downlink reception or uplink transmission,
wherein the MAC-CE is used to notify a beam indication of a backhaul link for the NCR.

18. The method of claim 17, wherein applying the (TCI) state or the SRI indicated by the MAC-CE for the downlink reception or uplink transmission comprises:
in case that the NCR is configured with a TCI state parameter, the MAC-CE includes a tenth field that indicates the TCI state, and the TCI state indicated by the tenth field is used for the downlink reception and uplink transmission; or
in case that the NCR is not configured with the TCI state parameter, the MAC-CE includes the tenth field and an eleventh field that indicates the SRI, and the TCI state indicated by the tenth field is used for the downlink reception and the SRI indicated by the eleventh field is used for the uplink reception.

19. The method of claim 18,
wherein the MAC-CE includes a twelfth field that indicates a resource type and a thirteenth field that indicates a resource identification ID, and
wherein applying the TCI state or the SRI indicated by the MAC-CE for the downlink reception or uplink transmission includes using the TCI state or the SRI indicated by the twelfth field and the thirteenth field for the downlink reception or uplink transmission.

20. A method performed by a network node in a wireless communication system, the method comprising:
transmitting network-controlled repeater (NCR) configuration information to an NCR; and
transmitting a first downlink control information format to the NCR,
wherein the NCR configuration information is used for the NCR to monitor or detect the first downlink control information format, and
wherein the first downlink control information format is used to notify a beam indication of an access link for the NCR.
